(19) United States
(12) Patent Application Publication
(10) Pub. No.: US 2003/0016251 A1
(43) Pub. Date: Jan. 23, 2003

(54) Command execution apparatus and command execution program storage medium

(75) Inventor: Hirokazu Kondo, Kanagawa (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 10/195,715

(22) Filed: Jul. 16, 2002

(30) Foreign Application Priority Data
Jul. 23, 2001 (JP) 2001-221490

(51) Int. Cl. G09G 5/00

(52) U.S. Cl. 345/846

(57) ABSTRACT

In a command execution apparatus having a display screen and a pointing device, wherein an icon, in which a command is defined, is displayed on the display screen and the command is executed in accordance with the icon designated upon receipt of an instruction of the icon by the pointing device, a consecutive works-icon display section displays on the display screen a consecutive works-icon associated with a series of works. A works-icon image plane display section displays on the display screen, upon receipt of designation of the consecutive works-icon by the pointing device, a works-icon image plane associated with the consecutive works-icon, in which a plurality of works-icons defining commands according to plural works constituting a series of works, is arranged in the same order as the working procedure of the series of works. A command execution section executes, upon receipt of designation of any one of the works-icons on the works-icon image plane displayed on the display screen, by the pointing device, a command according to the designated works-icon.

### BACKGROUND OF THE INVENTION

1. Field of the Invention

The present invention relates to a command execution apparatus wherein an icon, in which a command is defined, is displayed on a display screen and the command is executed in accordance with the icon designated upon receipt of an instruction of the icon by a pointing device, and a command execution program storage medium storing a command execution program which causes a computer to operate as such a command execution apparatus when the command execution program is incorporated into the computer.

2. Description of the Related Art

Hitherto, on a display screen of a computer, there are displayed icons each defining commands associated with various sorts of works to be executed in the computer, and when an operator designates a desired icon by a pointing device, for example, a mouse, a command associated with the icon is executed in the computer.

Individual icons displayed on the display screen on the computer are represented with patterns that symbolically represent execution commands when the commands associated with the icons are executed. Accordingly, representation of the individual icons with the patterns makes it possible for an operator to be reminded of the processing contents to be executed when the icons are designated, and thus the operator can operate the computer without being aware of complicated commands.

When a window of an application is displayed on a display screen of a computer in which application software is installed, a tool bar is displayed within the window. It often happens that there are displayed on the tool bar a plurality of icons, wherein commands according to a plurality of works are defined, which are deemed to be high in using frequency, for example, in case of an icon in which a command for executing a printing is defined, in such a manner that an icon of a pattern of a printer which reminds one of printing, in which the command is defined.

According to the conventional scheme as mentioned above, in the event that the work intended by an operator is completed in accordance with an execution of a certain command, for example, an execution of printing, representation of the individual icons with the patterns makes it possible for the operator to be reminded of the processing contents to be executed when the icons are designated, and thus designation of the icon associated with a command according to the content by the pointing device and execution of the command make it possible to surely complete the work.

However, in the event that a plurality of commands must be executed in accordance with a predetermined working procedure, there is a need to designate a plurality of icons wherein the plurality of commands are defined in accordance with the predetermined working procedure by the pointing device. In such a case, even if representation of the individual icons with the patterns makes it possible for the operator to be reminded of the processing contents to be executed when the icons are designated, it is difficult to surely complete the work, unless the operator understands the working procedure, for example, involving a possibility that some processes of a series of works will be omitted. Further, even if an operator, who understands the working procedure of a series of works, is concerned, in the event that the operator is inexperienced in operation, it is expected that the operator has to consider the subsequent operation whenever one process of the series of works is terminated, and thus an execution of the smooth working cannot be expected.

### SUMMARY OF THE INVENTION

In view of the foregoing, it is an object of the present invention to provide a command execution apparatus wherein a plurality of commands, which is executed in accordance with a predetermined working procedure, is surely and smoothly executed in accordance with the predetermined working procedure, and a command execution program storage medium storing a command execution program which causes a computer to operate as such a command execution apparatus when the command execution program is incorporated into the computer.

To achieve the above-mentioned object, the present invention provides a command execution apparatus having a display screen and a pointing device, wherein an icon, in which a command is defined, is displayed on the display screen and the command is executed in accordance with the icon designated upon receipt of an instruction of the icon by the pointing device, said command execution apparatus comprising:

a consecutive works-icon display section for displaying on the display screen a consecutive works-icon associated with a series of works;

a works-icon image plane display section for displaying on the display screen, upon receipt of designation of the consecutive works-icon by the pointing device, a works-icon image plane associated with the consecutive works-icon, in which a plurality of works-icons defining commands according to plural works constituting a series of works, is arranged in the same order as the working procedure of the series of works; and

a command execution section for executing, upon receipt of designation of any one of the works-icons on the works-icon image plane displayed on the display screen, by the pointing device, a command according to the designated works-icon.

According to the command execution apparatus having a display screen and a pointing device, wherein an icon, in which a command is defined, is displayed on the display screen and the command is executed in accordance with the icon designated upon receipt of an instruction of the icon by the pointing device, a consecutive works-icon display section displays on the display screen a consecutive works-icon associated with a series of works. A works-icon image plane display section displays on the display screen, upon receipt of designation of the consecutive works-icon by the pointing device, a works-icon image plane associated with the consecutive works-icon, in which a plurality of works-icons defining commands according to plural works constituting a series of works, is arranged in the same order as the working procedure of the series of works. A command execution section executes, upon receipt of designation of any one of the works-icons on the works-icon image plane displayed on the display screen, by the pointing device, a command according to the designated works-icon. Any one can grasp the entirety of the working procedure from the arrangement of the plurality of working icons and in addition can advance the works without considering the subsequent operation in the mid way of the works by sequentially designating the work-icons arranged in the same order as a series of works of working procedure. As a result, there is provide a command execution apparatus capable of reliably and smoothly executing a plurality of commands to be executed in accordance with a predetermined working procedure.

In the command execution apparatus according to the present invention as mentioned above, it is preferable that said works-icon image plane display section displays a works-icon image plane including a display indexing a works-icon defining a command to be executed next.

An operator can grasp the work to be executed next by an indication of index of the work-icon in which the command to be executed next is defined, and in addition can complete the works more reliably by advancing the works in accordance with those indications.

In the command execution apparatus according to the present invention as mentioned above, it is preferable that said works-icon image plane display section displays an explanatory note for a command to be executed next.

Indication of the explanatory note for the command to be executed next makes it possible for an operator to understand processing contents to be executed when a work-icon defining the command is designated, even if it is difficult for the operator to be reminded of the processing contents from a pattern of the work-icon.

In the command execution apparatus according to the present invention as mentioned above, it is preferable that said command execution section receives only either one designation of the works-icon in which the command immediately before executed is defined and the works-icon in which the command to be next executed is defined, of the works-icons arranged on the works-icon image plane, except for receiving an instruction of cancellation of a series of works associated with the works-icon image plane.

In this manner, limiting the work-icons that receive the designation makes it possible, for example, to avoid such an operator's mistake that an erroneous work-icon is designated omitting the necessary work, and thus it is possible to terminate the works more reliably. Still further, according to the command execution apparatus of the present invention, it is permitted also to receive the designation of the work-icon in which the command executed immediately before is defined, and thus it is possible also to alter the processed contents which are determined once in the work just before, for example, such a case where a mistake of setting in the previous step is corrected in the mid way of a series of works.

In the command execution apparatus according to the present invention as mentioned above, it is preferable that said command execution section sets up a result obtained by execution of a command associated with any of the works-icons on the works-icon image plane in form of data that is used when a command to be executed subsequently to the command (first occurrence) is executed.

In this manner, according to the profile creating apparatus including an embodiment of the command execution apparatus of the present invention, a result, which is obtained by the execution of the command associated with any one of work-icons, is set up as data used when the command to be executed next is executed, so that an operator's manual operation for performing such a set up can be omitted. Thus, it is possible to reduce the burden of an operator and in addition to reduce a possibility of the occurrence of setting errors as compared with the manual setting. Therefore, it is possible to complete the works more reliably.

In the command execution apparatus according to the present invention as mentioned above, it is preferable that said command execution apparatus further comprises a works procedure creating section for creating an arrangement of the works-icons on the works-icon image plane in accordance with an operation of the pointing device.

According to the command execution apparatus having the works procedure creation section as mentioned above, it is possible to change or modify a working procedure of a series of works, which has been already created, and also to newly create a working procedure of a series of works. Accordingly, it is possible to create an arrangement of work icons to meet an operator's requirement on a work-icon image plane.

To achieve the above-mentioned object, the present invention provides a command execution program storage medium storing a command execution program, which causes a computer having a display screen and a pointing device to operate as a command execution apparatus wherein an icon, in which a command is defined, is displayed on the display screen and the command is executed in accordance with the icon designated upon receipt of an instruction of the icon by the pointing device, when the color command execution program is incorporated in the computer to be executed, said color command execution apparatus comprising:

a consecutive works-icon display section for displaying on the display screen a consecutive works-icon associated with a series of works;

a works-icon image plane display section for displaying on the display screen, upon receipt of designation of the consecutive works-icon by the pointing device, a works-icon image plane associated with the consecutive works-icon, in which a plurality of works-icons defining commands according to plural works constituting a series of works, is arranged in the same order as the working procedure of the series of works; and

a command execution section for executing, upon receipt of designation of any one of the works-icons on the works-icon image plane displayed on the display screen, by the pointing device, a command according to the designated works-icon.

The command execution program stored in the command execution program storage medium of the present invention causes a computer to operate as a command execution apparatus when the command execution program is installed in the computer to be executed by a combination of the command execution program with an OS (Operation System) of the computer. The command execution program includes various aspects corresponding to the various aspects of the command execution apparatus of the present invention.

### BRIEF DESCRIPTION OF THE DRAWINGS

FIG. 1 is a whole structural view of a printing and proof image creating system to which an embodiment of the present invention is applied.

FIG. 2 is a perspective view of a spectrocolorimeter and a personal computer shown in FIG. 1.

FIG. 3 is a hardware construction view of the personal computer shown in FIG. 1.

FIG. 4 is a conceptual view of a printing profile.

FIG. 5 is a conceptual view of a printer profile.

FIG. 6 is a view of a combined profile in which a printing profile is combined with a printer profile.

FIG. 7 is a view showing an embodiment of a command execution program related to a command execution program storage medium of the present invention.

FIG. 8 is a functional block diagram of a profile creating apparatus including an embodiment of a command execution apparatus of the present invention constructed in the personal computer 80 shown in FIG. 1 and FIG. 2.

FIG. 9 is a view showing an example of an image plane displayed on a display screen of an image display unit.

FIG. 10 is a view showing an example of a consecutive works-icon display image plane displayed on a display screen of an image display unit.

FIG. 11 is a view showing an example of a work-icon image plane displayed on a display screen of an image display unit.

FIG. 12(a) and FIG. 12(b) are views each showing an example of an image plane displayed on a display screen of an image display unit.

FIG. 13 is a view showing an example of a form image plane displayed on a display screen of an image display unit.

FIG. 14 is a view showing an example of an image plane displayed on a display screen of an image display unit.

FIG. 15 is a view showing an example of an image plane displayed on a display screen of an image display unit.

FIG. 16 is a view showing an example of a form image plane displayed on a display screen of an image display unit.

FIG. 17 is a view showing an example of an image plane displayed on a display screen of an image display unit.

FIG. 18 is a view showing an example of a work-icon display image plane displayed on a display screen of an image display unit.

FIG. 19(a) and FIG. 19(b) are views each showing an example of an image plane displayed on a display screen of an image display unit.

FIG. 20 is a view showing an example of an image plane displayed on a display screen of an image display unit.

FIG. 21 is a view showing an example of an image plane displayed on a display screen of an image display unit.

FIG. 22 is a view showing an example of an image plane displayed on a display screen of an image display unit.

FIG. 23 is a view showing an example of an image plane displayed on a display screen of an image display unit.

FIG. 24 is a view showing an example of a work-icon display image plane displayed on a display screen of an image display unit.

FIG. 25 is a view showing an example of an image plane displayed on a display screen of an image display unit.

FIG. 26 is a view showing an example of an image plane displayed on a display screen of an image display unit.

FIG. 27 is a view showing an example of a work-icon display image plane displayed on a display screen of an image display unit.

FIG. 28 is a view showing an example of a work-icon display image plane displayed on a display screen of an image display unit.

FIG. 29 is a view showing an example of an image plane displayed on a display screen of an image display unit.

FIG. 30 is a view showing an example of a form image plane displayed on a display screen of an image display unit.

FIG. 31 is a view showing an example of a work-icon display image plane displayed on a display screen of an image display unit.

FIG. 32 is a view showing an example of an image plane displayed on a display screen of an image display unit.

FIG. 33 is a view showing an example of a work-icon display image plane displayed on a display screen of an image display unit.

FIG. 34 is a view showing an example of an image plane displayed on a display screen of an image display unit.

FIG. 35 is a view showing an example of an image plane displayed on a display screen of an image display unit.

FIG. 36 is a view showing an example of a work-icon display image plane displayed on a display screen of an image display unit.

FIG. 37 is a view showing an example of an image plane displayed on a display screen of an image display unit.

FIG. 38 is a view showing an example of a work-icon display image plane displayed on a display screen of an image display unit.

FIG. 39 is a first view showing an example of a customize image plane for a work flow to create an arrangement of work-icons on a work-icon display image plane, which is displayed on a display screen of an image display unit.

FIG. 40 is a second view showing an example of a customize image plane for a work flow to create an arrangement of work-icons on a work-icon display image plane, which is displayed on a display screen of an image display unit.

FIG. 41 is a third view showing an example of a customize image plane for a work flow to create an arrangement of work-icons on a work-icon display image plane, which is displayed on a display screen of an image display unit.

### DETAILED DESCRIPTION OF PREFERRED EMBODIMENTS

Embodiments of the present invention will be described with reference to the accompanying drawings.

Here, there will be explained an example in which a command execution apparatus is applied to a profile creating apparatus.

The profile creating apparatus is an apparatus for creating a desired profile in accordance with a scheme that a target device such as a printing machine is used to output a color chart defined by coordinate values on a color space of the target device, wherein a plurality of color patches is arranged, and the plurality of color patches constituting the outputted color chart is measured to obtain calorimetric data defined by coordinate values on a calorimetric color space, so that there is created a target profile representative of the association between the coordinate values on the color space of the target device and the coordinate values on the calorimetric color space. The profile creating apparatus of the present embodiment has further a function in which the accuracy evaluation of the already created profile is executed, and the already created profile is controlled in accordance with the accuracy evaluation.

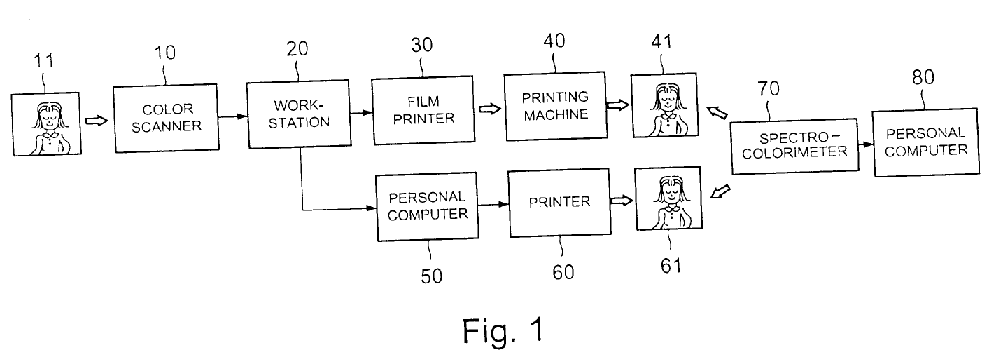

FIG. 1 is a whole structural view of a printing and proof image creating system to which an embodiment of the present invention is applied.

A color scanner 10 creates reads an original image 11 to create color separation image data for four colors of C (cyan), M (magenta), Y (yellow), and K (black), which is representative of the original image 11. This image data of CMYK is fed to a workstation 20. In the workstation 20, an operator performs an electronic page make-up in accordance with the entered image data to create image data representative of an image for printing. The image data for printing is fed to a film printer 30 in the event that a printing is carried out. The film printer 30 creates printing film original plates for CMYK associated with the entered image data.

A machine plate is created from the printing film original plates, and the created machine plate is mounted on a printing machine 40. Ink is applied to the machine plate mounted on the printing machine 40, and the applied ink is transferred to a printing sheet to form a printed image 41 on the sheet.

Such a series of work that film original plates are created by the film printer 30; a machine plate is created and then mounted on the printing machine 40; ink is applied to the machine plate; and a printing is performed on a sheet, is a large-scale work and costs a great deal. For this reason, before the actual printing work is carried out, a printer 60 is used to create a proof image 61 in the manner as set forth below, and a prior estimate for finish of the proof image is performed.

To create the proof image, image data, which is created by an electronic page make-up on the, is fed to a personal computer 50. The image data fed to the personal computer 50 is a description language described in a so-called PDL (Page Description Language). In the personal computer 50, a so-called RIP (Raster Image Processor) is used to convert the description language described in a so-called PDL into image data for CMYK four colors that is developed in a bit map. The image data for CMYK four colors is substantially the same as the image data for printing fed to the film printer 30.

The image data for printing for CMYK four colors is converted into the image data for CMYK four colors suitable for the printer 60 through referring to a color conversion definition having a format of an LUT (Look Up Table) inside the personal computer 50. The image data for CMYK four colors for the printer is fed to the printer 60. The printer 60 creates the proof image 61 in accordance with the image data for CMYK four colors for the printer.

A degree of coincidence in color between the image 41 obtained by printing of the printer machine 40 and the proof image obtained by the printer 60 is determined by the color conversion definition inside the personal computer 50. The color conversion definition is created for each printing condition on each printer.

While FIG. 1 shows only one printing machine, it is acceptable that a plurality of printing machine exist, or it is acceptable that while one printing machine is concerned, a plurality of printing conditions exist. The color conversion definition is created in accordance with a plurality of printing conditions including a difference between the printing machines. In other words, the color conversion definition is created in accordance with a combination of the respective printing condition and the respective printer (in the event that only one printer is concerned and a plurality of printing conditions exists, the respective printing conditions). A spectrocolorimeter 70 and a personal computer 80, which are shown in FIG. 1, are concerned with a creation of the color conversion definition.

Thus, when the proof image is created and then confirmed, it is possible to predict a finish of the printing.

An aspect of the embodiment of the present invention in the proof image creating system shown in FIG. 1 resides in processing contents to be executed inside the personal computer 80. And thus, hereinafter, there will be explained the personal computer 80.

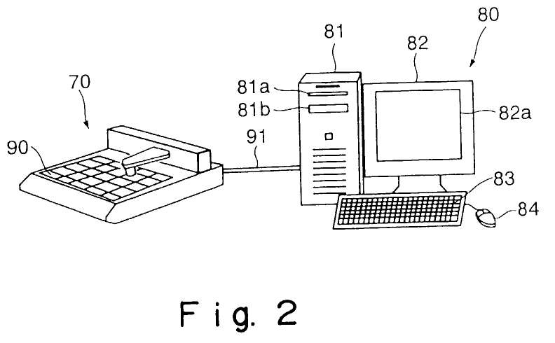

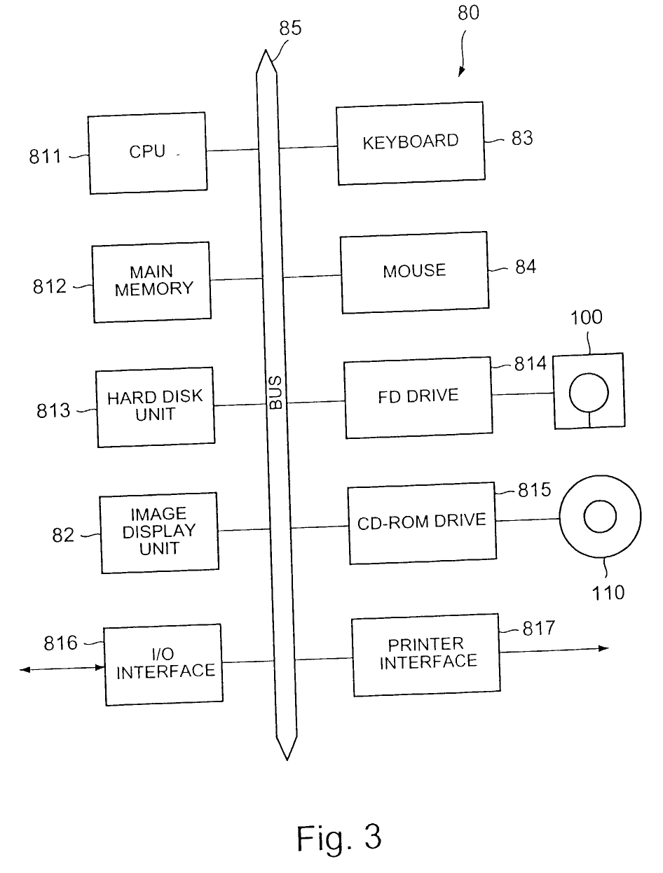

FIG. 2 is a perspective view of the spectrocolorimeter 70 and the personal computer 80 shown in FIG. 1. FIG. 3 is a hardware construction view of the personal computer 80 shown in FIG. 1.

A color chart 90, in which a plurality of color patches is arranged, is set to the spectrocolorimeter 70 shown in FIG. 2 so that colorimetric values (here L*a*b*) are measured on the plurality of color patches constituting the color chart 90. Colorimetric data representative of the values of the color patches obtained through measurement by the spectrocolorimeter 70 are fed via a cable 91 to the personal computer 80.

The color chart 90 is created by printing of the printing machine 40 shown in FIG. 1 or by print out of the printer 60 shown in FIG. 1. The personal computer 80 knows color data (coordinates on the device color space; values of CMYK or RGB) associated with the color patches constituting the color chart 90, and creates a printing profile and a printer profile in accordance with the color data for the color patches constituting the color chart 90 and the colorimetric data obtained through the spectrocolorimeter 70. In this respect, the detailed explanation will be made later. Here, there will be explained a hardware construction of the personal computer 80 hereinafter.

The personal computer 80 comprises, on an appearance basis, a main frame unit 81, an image display unit 82 for displaying an image on a display screen 82a in accordance with an instruction from the main frame unit 81, a keyboard 83 for entering user's instruction and various sort of information according to the key operation into the main frame unit 81, and a mouse 84 for designating an arbitrary position on the display screen 82a to enter an instruction according to for example an icon displayed on the designated position. The main frame unit 81 has on an appearance basis an FD mounting slot 81a for mounting a flexible disk (FD) and a CD-ROM mounting slot 81b for mounting a CD-ROM.

The main frame unit 81 incorporates therein, as shown in FIG. 3, a CPU 811 for executing a various sort of programs; a main memory 812 for reading a program stored in a hard disk unit 813 to develop the same for execution in the CPU 811; a hard disk unit 813 for storing various programs and data; an FD drive 814 for accessing an FD 100 mounted; a CD-ROM drive 815 for accessing a CD-ROM 110 mounted; an I/O interface 816 connected to the spectrocolorimeter 70 (cf. FIG. 1 and FIG. 2) for receiving the calorimetric data from the spectrocolorimeter 70; and a printer interface 817 for sending image data to the printer 60. Those various elements are connected via a bus 85 to the image display unit 82, the keyboard 83 and the mouse 84, which are shown in FIG. 2 too.

The CD-ROM 110 stores therein a command execution program for causing the personal computer 80 to operate as a profile creating apparatus including an embodiment of a command execution apparatus of the present invention. The CD-ROM 110 is mounted on the CD-ROM drive 815 so that a command execution program stored in the CD-ROM 110 is uploaded onto the personal computer 80 and is stored in the hard disk unit 813.

Incidentally, it is noted that functions of creation of the profile and the color conversion definition, which will be described hereinafter, and functions of accuracy evaluation and control of already created profile, by the personal computer 80, are not the subject of the present invention and it is assumed that programs necessary for implementing those functions are already installed in the personal computer 80.

Next, there will be explained a creation procedure of the color conversion constructed in the personal computer 80.

Here, first, a printing profile is created.

In the workstation shown in FIG. 1, dot % data for CMYK four colors are sequentially varied, for example, 0%, 10%, . . . , and 100%, and a color chart based on the dot % data thus generated is created in accordance with the above-mentioned printing procedure. While the image 41 shown in FIG. 1 is not an image representative of a color chart, the spectrocolorimeter 70 is used to measure color patches constituting the color chart assuming that the color chart, which is the same as the color chart 90 shown in FIG. 2, instead of the image 41, is printed. Thus, there is constructed a printing profile representative of the association between coordinate values on a color space for CMYK four colors and coordinate values on a calorimetric color space.

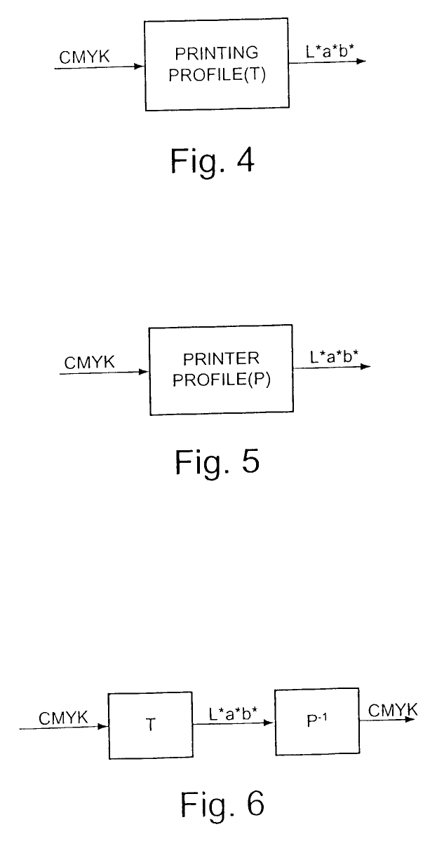

FIG. 4 is a conceptual view of a printing profile.

The printing profile receives image data defined by CMYK and converts the image data defined by CMYK into image data defined by L*a*b*.

Next, a printer profile is created.

A creating procedure of the printer profile is the same as that of the printing profile excepting that the output device for outputting the color chart is a printer but not the printing machine. That is, here, in the personal computer 50 shown in FIG. 1, dot % data for CMYK four colors are sequentially varied 0%, 10%, . . . , and 100%, on each color, and the dot % data thus generated are sent to the printer 60 so that the printer 60 prints out the color chart in accordance with dot % data. While the image 61 shown in FIG. 1 is not an image representative of a color chart, the spectrocolorimeter 70 is used to measure color patches constituting the color chart assuming that the color chart, which is of the same type as the color chart created through printing by the printing machine 40 for creating the printing profile, instead of the image 61, is outputted. Thus, there is constructed a printer profile representative of the association between coordinate values on a color space for CMYK four colors and coordinate values on a calorimetric color space (L*a*b* space) on a printer.

FIG. 5 is a conceptual view of a printer profile.

The printer profile receives dot % data for CMYK and converts the dot % data for CMYK into calorimetric data defined by L*a*b*. Here, a printer profile (a forward transformation printer profile) for converting the dot % data for CMYK into colorimetric data of L*a*b* is represented by P. Inversely, a printer profile (an inverse transformation printer profile) for converting the calorimetric data of L*a*b* into the dot % data for CMYK is represented by P⁻¹.

While it is explained that the printer 60 is a printer in which an image is outputted in accordance with dot % data for CMYK, it is acceptable, also regarding a printer for outputting an output according to for example RGB data, that the personal computer 50 generates data defined in the RGB space to output the color chart, so that a printer profile suitable for the printer can be created in a similar fashion to that of the printer 60.

However, the explanation will be continued assuming that there is used the printer 60 for outputting the image in accordance with dot % data for CMYK.

FIG. 6 is a view of a combined profile in which a printing profile is combined with a printer profile.

Dot % data for CMYK for printing is converted into colorimetric data of L*a*b* by the printing profile T, and then the calorimetric data of L*a*b* is converted into the dot % data for CMYK, but for a printer, by the inverse transformation printer profile P⁻¹. The printer 60 can output a proof image of the same color as the printing in accordance with the dot % data for CMYK for a printer thus generated. A combined profile, in which the printing profile T is combined with the inverse transformation printer profile P⁻¹, is a color conversion definition for conversion from the CMYK color space for printing to the CMYK color space for a printer.

A proof image for an image of printing is created in such a manner that the personal computer 80, which constitutes the printing and proof image creating system shown in FIG. 1, creates a color conversion definition as mentioned above; the color conversion definition thus created is installed in the personal computer 50, which constitutes the printing and proof image creating system shown in FIG. 1; image data described in the PDL entered from the workstation 20 are converted into image data for CMYK and thereafter the image data for CMYK are converted into image data for CMYK for a printer using the color conversion definition; and the printer 60 prints out an image in accordance with the image data for CMYK for a printer.

Incidentally, there is no need that the personal computer 80 shown in FIG. 1 creates up to the combined profile. It is acceptable that the personal computer 80 creates a printing profile or a printer profile and then feeds the same to the personal computer 50, so that the personal computer 50 creates the combined profile.

Next, there will be explained display states of the profiles created in the manner as mentioned above by the personal computer 80.

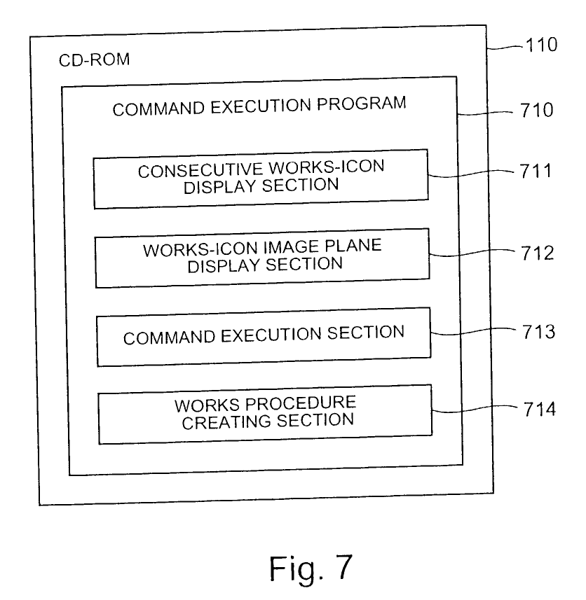

FIG. 7 is a view showing an embodiment of a command execution program related to a command execution program storage medium of the present invention.

Here, the command execution program is stored in the CD-ROM 110 shown in FIG. 3.

A command execution program 710 shown in FIG. 7 comprises a consecutive works-icon display section 711, a works-icon image plane display section 712, a command execution section 713 and a works procedure creating section 714. There will be described later operations of those program components.

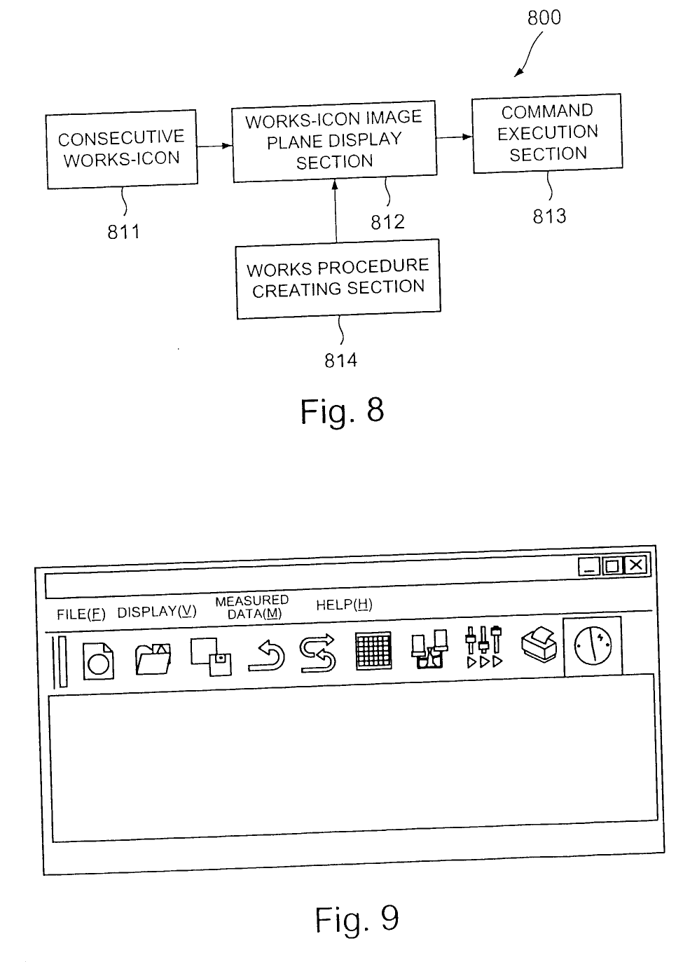

FIG. 8 is a functional block diagram of a profile creating apparatus including an embodiment of a command execution apparatus of the present invention constructed in the personal computer 80 shown in FIG. 1 and FIG. 2.

A profile creating apparatus 800 shown in FIG. 8 is implemented in such a manner that the command execution program 710 shown in FIG. 7 is loaded onto the personal computer 80 shown in FIG. 1, FIG. 2 and FIG. 3, and in the personal computer 80, the command execution program 710 shown in FIG. 7 is combined with programs necessary for implementing functions of creating a profile and a color conversion definition and functions of accuracy evaluation and control of the profile, which are already installed in the personal computer 80, and an OS (operation system) of the personal computer 80.

The profile creating apparatus 800 shown in FIG. 8 comprises a consecutive works-icon display section 811, a works-icon image plane display section 812, a command execution section 813 and a works procedure creating section 814. The consecutive works-icon display section 811, the works-icon image plane display section 812, the command execution section 813 and the works procedure creating section 814 are constituted of combinations of the consecutive works-icon display section 711, the works-icon image plane display section 712, the command execution section 713 and the works procedure creating section 714, which are given as software components shown in FIG. 7, with the hardware and the OS of the personal computer 80 shown in FIG. 1, FIG. 2 and FIG. 3, respectively. The consecutive works-icon display section 811, the works-icon image plane display section 812, the command execution section 813 and the works procedure creating section 814, of the profile creating apparatus 800 shown in FIG. 8 correspond to the consecutive works-icon display section 711, the works-icon image plane display section 712, the command execution section 713 and the works procedure creating section 714, of the command execution program 710 shown in FIG. 7, respectively. It is noted that while the same names are applied, the structural elements shown in FIG. 8 implies a composite of a hardware and a software, and on the other hand, the structural elements of the command execution program 710 shown in FIG. 7 implies only a part of the application software.

Hereinafter, there will be explained the respective structural elements of the profile creating apparatus 800 shown in FIG. 8, and whereby the respective structural elements of the command execution program 710 shown in FIG. 7 will be also explained.

The consecutive works-icon display section 811 of the profile creating apparatus 800 shown in FIG. 8 is implemented in such a manner that the consecutive works-icon display section 711 of the command execution program 710 shown in FIG. 7 is installed in the personal computer 80 shown in FIG. 1, FIG. 2 and FIG. 3, and the consecutive works-icon display section 711 is combined with the OS of the personal computer 80. The consecutive works-icon display section 811 displays on the display screen 82a shown in FIG. 2 a consecutive works-icon associated with a series of works for creation of a profile or accuracy evaluation and control of the profile. The consecutive works-icon display section 811 corresponds, on a hardware basis, a combination of the keyboard 83 or the mouse 84 shown in FIG. 2 and FIG. 3, the image display unit 82, and the CPU 811 for executing the consecutive works-icon display section 711 (cf. FIG. 7) as a program component.

The works-icon image plane display section 812 is implemented in such a manner that the works-icon image plane display section 712 of the command execution program 710 shown in FIG. 7 is installed in the personal computer 80 shown in FIG. 1, FIG. 2 and FIG. 3, and the works-icon image plane display section 712 is combined with the OS of the personal computer 80. The works-icon image plane display section 812 displays on the display screen 82a shown in FIG. 2, upon receipt of designation of a consecutive works-icon displayed by the consecutive works-icon display section 811, by the mouse 84 shown in FIG. 2 and FIG. 3, a works-icon image plane associated with the consecutive works-icon, in which a plurality of works-icons defining commands according to plural works constituting a series of works for creation of a profile or accuracy evaluation and control of the profile, is arranged in the same order as the working procedure of the series of works. The works-icon image plane display section 812 further displays a works-icon image plane including a display indexing a works-icon defining a command to be executed next. The works-icon image plane display section 812 furthermore displays an explanatory note for a command to be executed next. The works-icon image plane display section 812 corresponds, on a hardware basis, a combination of the keyboard 83 or the mouse 84 shown in FIG. 2 and FIG. 3, the image display unit 82, and the CPU 811 for executing the works-icon image plane display section 712 (cf. FIG. 7) as a program component.

The command execution section 813 is implemented in such a manner that the command execution section 713 of the command execution program 710 shown in FIG. 7 is installed in the personal computer 80 shown in FIG. 1, FIG. 2 and FIG. 3, and the command execution section 713 is combined with the OS of the personal computer 80. The command execution section 813 executes, upon receipt of designation of any of the works-icons on the works-icon image plane display section 812, which is displayed on the display screen 82a shown in FIG. 2, by the mouse 84 shown in FIG. 2 and FIG. 3, a command according to the designated works-icon. The command execution section 813 receives only either one designation of the works-icon in which the command immediately before executed is defined and the works-icon in which the command to be next executed is defined, of the works-icons arranged on the works-icon image plane, except for receiving an instruction of cancellation of a series of works for creation of a profile or accuracy evaluation and control of the profile. The command execution section 813 sets up a result obtained by execution of a command associated with any of the works-icons on the works-icon image plane in form of data that is used when a command to be executed subsequently to the command (first occurrence) is executed. The command execution section 813 corresponds, on a hardware basis, a combination of the keyboard 83 or the mouse 84 shown in FIG. 2 and FIG. 3, the image display unit 82, and the CPU 811 for executing the command execution section 713 (cf. FIG. 7) as a program component.

The works procedure creating section 814 is implemented in such a manner that the works procedure creating section 714 of the command execution program 710 shown in FIG. 7 is installed in the personal computer 80 shown in FIG. 1, FIG. 2 and FIG. 3, and the works procedure creating section 714 is combined with the OS of the personal computer 80. The works procedure creating section 814 creates an arrangement of the works-icons on the works-icon image plane in accordance with the operation of the mouse 84 shown in FIG. 2 and FIG. 3. The works procedure creating section 814 corresponds, on a hardware basis, a combination of the keyboard 83 or the mouse 84 shown in FIG. 2 and FIG. 3, the image display unit 82, and the CPU 811 for executing the works procedure creating section 714 (cf. FIG. 7) as a program component.

Hereinafter, there will be explained concrete display states in the consecutive works-icon display section 811, the works-icon image plane display section 812, the command execution section 813 and the works procedure creating section 814 in conjunction with an example of a profile creating apparatus including a command execution apparatus of the present invention constructed in the personal computer 80 shown in FIG. 1 and FIG. 2.

FIG. 9 is a view showing an example of an image plane displayed on the display screen 82a of the image display unit 82, for implementing functions of creating a profile and a color conversion definition and functions of accuracy evaluation and control of the profile.

When a predetermined operation is performed by the keyboard 83 or the mouse 84 of the personal computer 80 shown in FIG. 1, FIG. 2 and FIG. 3, the image plane shown in FIG. 9 is displayed on the display screen 82a of the image display unit 82 of the personal computer 80.

On the top of the image plane shown in FIG. 9, there is displayed a menu for implementing functions of creating a profile and a color conversion definition and functions of accuracy evaluation and control of the profile. Below the menu, there is displayed a tool bar on which ten sorts of icons are displayed with patterns that are symbolically representative of a plurality of execution commands which is high in frequency in use. Specifically, from the left of the tool bar, there are displayed a “new creation” icon, an “open a profile” icon, a “save a profile” icon, a “cancellation” icon, a “do over again” icon, a “chart measurement” icon, an “evaluation chart comparison” icon, an “automatic control” icon, a “print information and evaluation result of a profile” icon, and a “navigator” icon, in the name order.

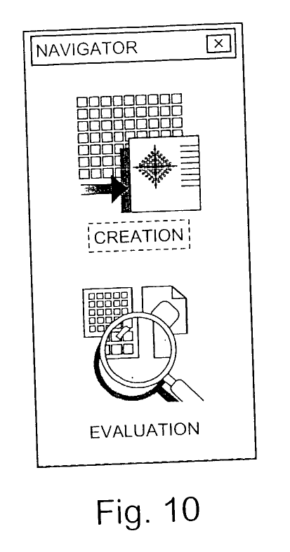

FIG. 10 is a view showing an example of a consecutive works-icon display image plane displayed on the display screen 82a (cf. FIG. 2) of the image display unit 82 by the consecutive works-icon display section 811 of the profile creating apparatus 800 shown in FIG. 8.

The consecutive works-icon display image plane shown in FIG. 10 is displayed when the “navigator” icon displayed at the right end on the tool bar shown in FIG. 9 is clicked through operation of the mouse.

On the upper portion of the consecutive works-icon display image plane there is displayed a “creation” consecutive works-icon associated with a series of works for creation of a profile. On the lower portion of the consecutive works-icon display image plane there is displayed an “evaluation” consecutive works-icon associated with a series of works for accuracy evaluation and control of the profile.

First, there will be explained an example in which when the “creation” consecutive works-icon is clicked, a series of works for creating a profile is executed.

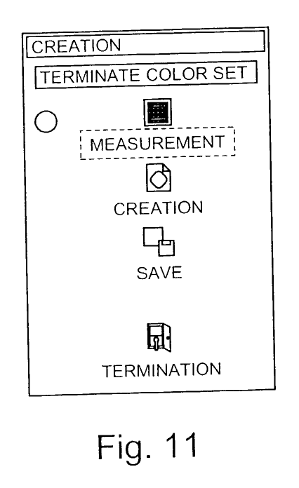

FIG. 11 is a view showing an example of a work-icon image plane displayed on the display screen 82a (cf. FIG. 2) of the image display unit 82 by the works-icon image plane display section 812 of the profile creating apparatus 800 shown in FIG. 8.

The work-icon image plane shown in FIG. 11 is displayed when the “creation” consecutive works-icon, which is displayed at the upper portion of the consecutive works-icon display image plane shown in FIG. 10, is clicked.

At the upper portion of the works-icon image plane, there is displayed a display column in which an explanatory note for a command to be executed next is displayed. Here, as an example of the explanatory note to be displayed on the display column, there is shown one in which a sentence of contents that “please confirm the completion of set up of colorimetry and start a measurement” is displayed on a scroll basis. Below the display column for the explanatory note there is displayed a plurality of works-icons defining commands according to plural works constituting a series of works for creation of a profile, is arranged in the same order as the working procedure of the series of works. Here, a “measurement” work-icon, a “creation” work-icon, a “saving” work-icon, and a “termination” work-icon are disposed and displayed in the same order as the working procedure of the series of works for a profile from the upper part to the lower part of the image plane. Further, at the left side of those work-icons, there is provided a display column to index the work-icon in which the command to be executed next is defined. Here, the index, which is indicative of that the command to be executed next is the “creation” work-icon, is displayed at the left side of the “measurement” work-icon.

According to the present embodiment as mentioned above, an explanatory note for a command to be executed next is displayed on a scroll basis at the display column on the works-icon image plane. However, the present invention is not restricted to such embodiment. It is acceptable that an explanatory note for a command to be executed next is not displayed on the works-icon image plane, for example, one in which when a mouse cursor is superposed on a desired work-icon, a balloon is displayed and the explanatory note is displayed on the balloon.

In the execution of the work-icons displayed on the works-icon image plane, the section 813 of the profile creating apparatus 800 shown in FIG. 8 receives only the designation of either one of the work-icon in which the command immediately before executed is defined and the work-icon in which the command to be executed next is defined, of the series of works associated with the works-icon image plane, here, the work-icons arranged on the works-icon image plane, except for receiving an instruction of stopping the creation of the profile. Consequently, here, it is possible to designate only the “measurement” work-icon and the “termination” work-icon.

Hereinafter, there will be explained operations after the work-icons on the works-icon image plane shown in FIG. 11 are clicked, in accordance with a work procedure of a series of works for creation of a profile.

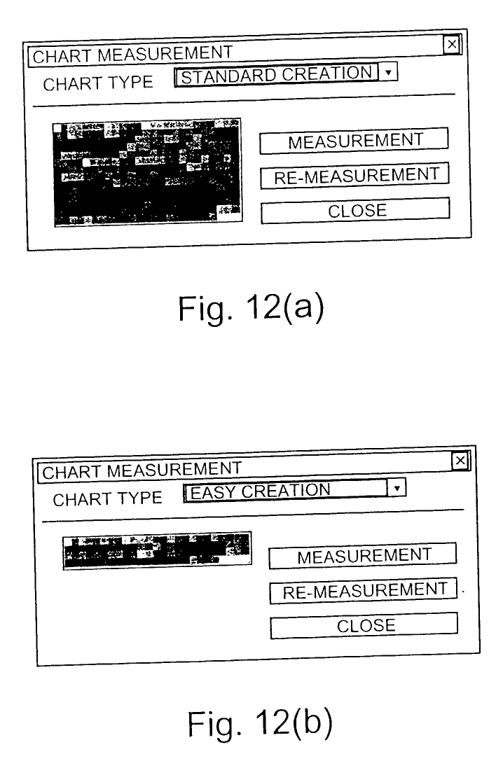

FIG. 12(a) and FIG. 12(b) are views each showing an example of the image plane 82a (cf. FIG. 2) displayed on the display screen of an image display unit 82, for execution of the creation of a profile.

When the “measurement” work-icon shown in FIG. 11 is clicked, the command execution section 813 of the profile creating apparatus 800 shown in FIG. 8 executes the command according to the designated work-icon so that the result of the execution is displayed on the image plane shown in FIG. 12(a) and FIG. 12(b).

According to the present embodiment, as a color chart used in creation of a profile, there are prepared two types of color charts of “standard” and “easiness”. FIG. 12(a) shows an image plane in which an image for a “standard” of color chart (here this image is also referred to as the color chart) is displayed. FIG. 12(b) shows an image plane in which an image for an “easiness” of color chart (here this image is also referred to as the color chart) is displayed. When an operator clicks a “measurement” button displayed lower right of the image plane in which a color chart that is the same sort as the color chart to be used in creation of a profile is displayed, the process goes to the subsequent working process for creation of a profile.

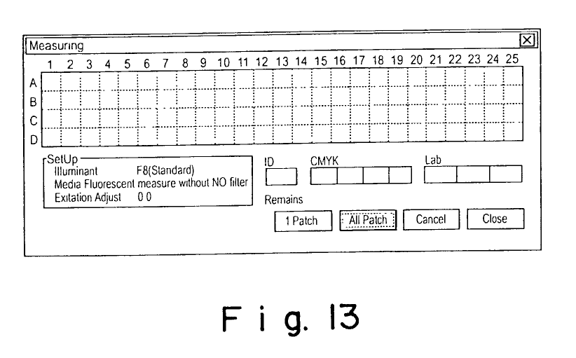

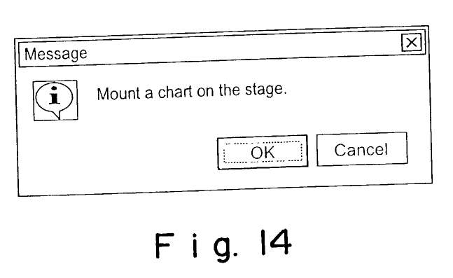

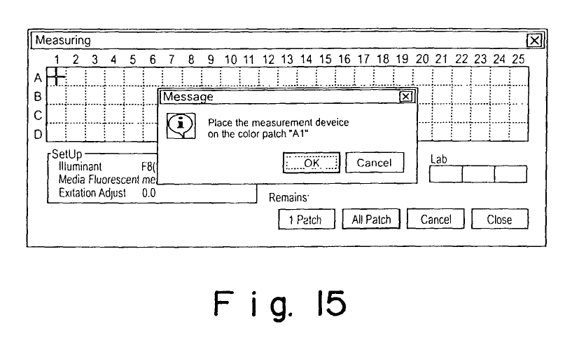

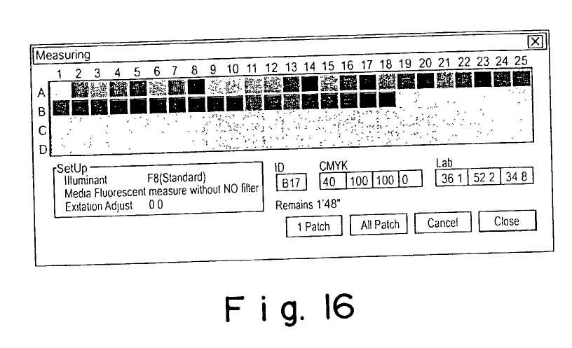

FIG. 13 is a view showing an example of a form image plane displayed on the image plane 82a (cf. FIG. 2) displayed on the display screen of an image display unit 82, for execution of the creation of a profile.

The form image plane shown in FIG. 13 is displayed when the “measurement” button shown in FIG. 12(a) and FIG. 12(b) is clicked.

FIG. 13 shows the form image plane after the “measurement” button shown in FIG. 12(b), which is concerned with the image plane wherein an “easiness” of color chart is displayed, is clicked. This form image plane provides a form according to the color chart for the “easiness” which is the selected chart type. When an “All Patch” button displayed lower right of the form image plane is clicked, the spectrocolorimeter 70 shown in FIG. 1 and FIG. 2 is initialized so that the process goes to the subsequent working process for creation of a profile. Functions other than the “All Patch” button on the form image plane will be described later.

FIG. 14 is a view showing an example of the image plane 82a (cf. FIG. 2) displayed on the display screen of an image display unit 82, for execution of the creation of a profile.

The image plane shown in FIG. 14 is displayed when the “All Patch” button shown in FIG. 13 is clicked.

A color chart, here, the “easiness” of color chart is put on the spectrocolorimeter 70 shown in FIG. 1 and FIG. 2 in accordance with the message displayed on this image plane. After the color chart is put on the spectrocolorimeter 70, clicking of an “OK” button on the image plane makes it possible to advance the working process for creation of a profile.

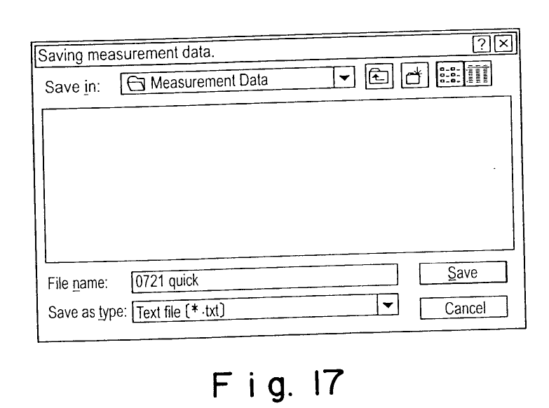

FIG. 15 is a view showing an example of the image plane 82a (cf. FIG. 2) displayed on the display screen of an image display unit 82, for execution of the creation of a profile.

The image plane shown in FIG. 15 is displayed in form that it is superposed on the form image plane shown in FIG. 13, when the “OK” button shown in FIG. 14 is clicked.

At the upper portion of the form image plane shown in FIG. 13, there is prepared a frame in which an image (here this image is also referred to as the color chart) for color patches associated with the color patches of the color chart measured is displayed. When the “OK” button is clicked in accordance with the message displayed on the image plane shown in FIG. 15, a positioning is performed by a positioning button (not illustrated) provided on the spectrocolorimeter 70, at the positions upper left, upper right and lower left in the frame of the upper portion of the form image plane shown in FIG. 13. At the position lower right of the frame of the upper portion of the form image plane shown in FIG. 13, there are provided columns for displaying Ids, CMYK values and L*a*b* values for the measured color patches. When the positioning is completed, automatically, a measurement for the color patches is sequentially performed.

FIG. 16 is a view showing an example of a form image plane displayed on the image plane 82a (cf. FIG. 2) displayed on the display screen of an image display unit 82, for execution of the creation of a profile.

The form image plane shown in FIG. 16 is a form image plane in measurement of the color patches after a measurement of the color patches of the color chart is automatically started after completion of the positioning by clicking the “OK” button shown in FIG. 15. This form image plane represents an image plane in a state that part of the measured data of the measured color patches is displayed on the form image plane shown in FIG. 13. Hereinafter, there will be explained parts, which are omitted in explanation as to the form image plane shown in FIG. 13, using the form image plane shown in FIG. 16.

As shown in FIG. 16, Ids, CMYK values and L*a*b* values for the color patches in measurement of the color chart are displayed lower right of the frame upper the form image plane, and an image (here this image is also referred to as the color chart) for color patches associated with the color patches of the color chart measured is displayed in the frame upper the form image plane. Below the columns for displaying the Ids, the CMYK values and the L*a*b* values for the color patches, there is displayed the time required for completion of a measurement. Lower left the frame upper the form image plane there is displayed set up information of the spectrocolorimeter 70 shown in FIG. 1 and FIG. 2. When the mouse cursor meets any one of a plurality of color patches displayed in the frame upper the form image plane after a measurement for all the color patches is terminated, the Id, the CMYK values and the L*a*b* values for the color patch designated by the mouse cursor are displayed at the right side of the frame. When a “Close” button displayed lower right the form image plane is clicked after a measurement for all the color patches is terminated, it is possible to advance the working process for creation of a profile.

FIG. 17 is a view showing an example of the image plane 82a (cf. FIG. 2) displayed on the display screen of an image display unit 82, for execution of the creation of a profile.

The image plane shown in FIG. 17 is displayed when the “Close” button shown in FIG. 16 is clicked.

This image plane is an image plane in which measured data obtained through measuring the color patches of the color chart are named and saved. A set up for saving data is completed in such a manner that a folder, in which data is to be saved, is designated in a “Save in” column displayed upper the image plane, a desired file name is entered into a “File name” column displayed lower the image plane, and a type of the file is selected in a “Save as type” displayed below the “File name” column. After the completion of set up, a “Save” button displayed lower right the image plane is clicked, so that the measured data obtained through measuring the color patches of the color chart are saved, and the process goes to the subsequent working process for creation of a profile.

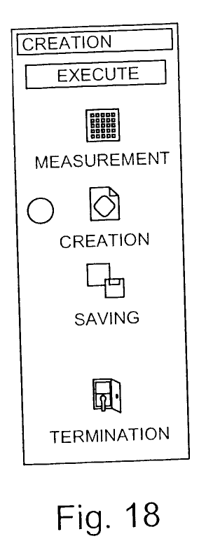

FIG. 18 is a view showing an example of a work-icon image plane displayed on the image plane 82a (cf. FIG. 2) displayed on the display screen of an image display unit 82 by the works-icon image plane display section 812 of the profile creating apparatus 800 shown in FIG. 8.

The work-icon image plane shown in FIG. 18 is displayed when the “Save” button shown in FIG. 17 is clicked.

Upper the image plane on the work-icon image plane, there is displayed a display column in which explanatory note for a command to be executed next is displayed. Here, as an example of the explanatory note to be displayed on the display column, there is shown one in which a sentence of contents that “please confirm the completion of the measurement and execute a new creation” is displayed on a scroll basis. Here, of a “measurement” work-icon, a “creation” work-icon, a “saving” work-icon, and a “termination” work-icon, which are disposed and displayed in the same order as the working procedure of the series of works for a profile from the upper part to the lower part of the image plane, the index, which is indicative of that the command to be executed next is the “creation” work-icon, is displayed at the left side of the “creation” work-icon.

Here, it is permitted that only the “measurement” work-icon, the “creation” work-icon, and the “termination” work-icon are designated by the command execution section 813 of the profile creating apparatus 800 shown in FIG. 8.

Other points of the work-icon image plane shown in FIG. 18 and the details of the functions are the same as the work-icon image plane shown in FIG. 11, and thus redundant explanation will be omitted.

When a “creation” work-icon displayed on the work-icon image plane shown in FIG. 18 is clicked, it is possible to advance the working process for creation of a profile.

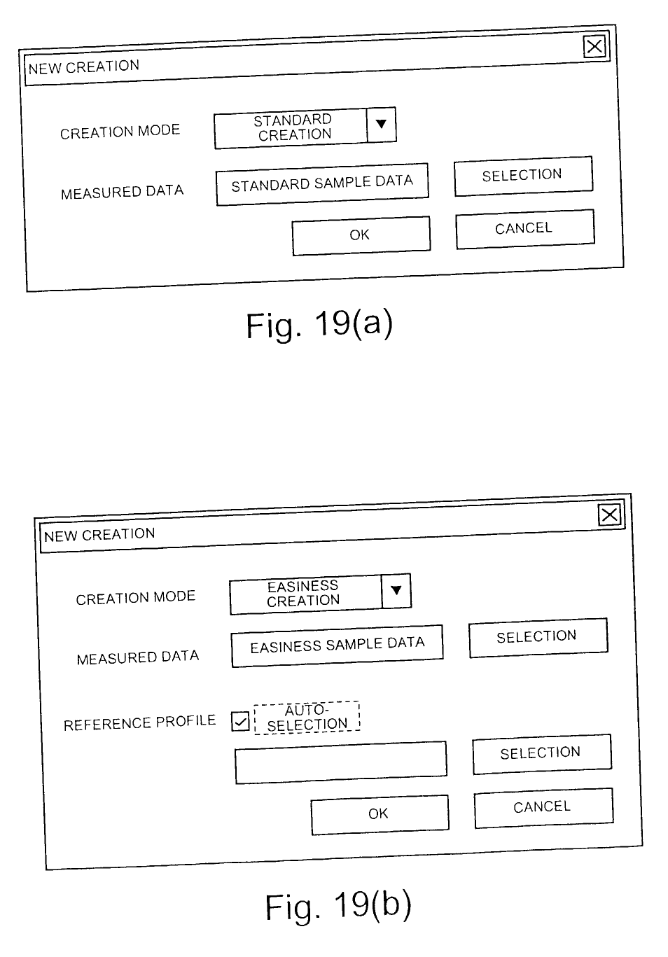

FIG. 19(a) and FIG. 19(b) are views each showing an example of the image plane 82a (cf. FIG. 2) displayed on the display screen of an image display unit 82, for execution of the creation of a profile.

When the “measurement” work-icon shown in FIG. 11 is clicked, the command execution section 813 of the profile creating apparatus 800 shown in FIG. 8 executes the command according to the designated work-icon, so that the image planes shown in FIG. 19(a) and FIG. 19(b) are displayed.

FIG. 19(a) shows an image plane, which is displayed after the color chart of the “standard” is measured, and FIG. 19(b) shows an image plane, which is displayed after the color chart of the “easiness” is measured. As a result of execution of the command associated with the “measurement” work-icon shown in FIG. 11 by the command execution section 813 of the profile creating apparatus 800 shown in FIG. 8, the measured data, after the color chart of the “easiness” named and saved on the image plane shown in FIG. 17 is measured, is set up in form of the measured data in the measured data column shown in FIG. 19(a) and FIG. 19(b). Thus, in the actual working, an image plane, which is displayed after the color chart of the “easiness” shown in FIG. 19(b) is measured, is displayed. When the automatic selection is set up to be effective in a check box of a reference profile provided below a measured data column, which is shown in FIG. 19(b), the system automatically analyzes the measured data of the color chart of the “easiness” and searches for the optimum one from among the profiles incorporated in the system beforehand to adopt the searched optimum one as a base profile.

When an “OK” button displayed below the image plane shown in FIG. 19(b) is clicked, the creation work for a profile is executed, and it is possible to advance the working process for creation of a profile.

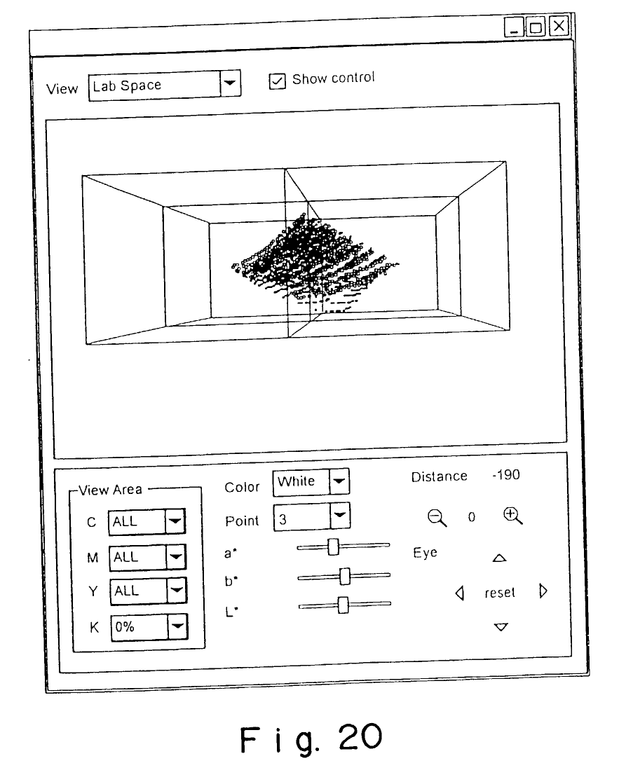

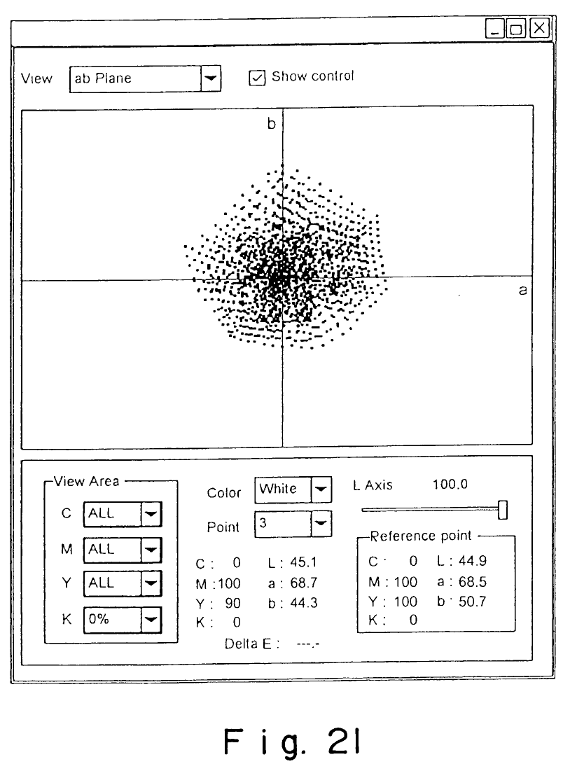

FIG. 20 is a view showing an example of the image plane 82a (cf. FIG. 2) displayed on the display screen of an image display unit 82, for execution of the creation of a profile.

The image plane shown in FIG. 20 is displayed when the “OK” button shown in FIG. 19 is clicked.

This image plane represents an image of a three-dimensional display in an L*a*b* space of the created profile. Operation of various buttons displayed at the under portion of the image plane by a mouse makes it possible to provide not only a rotary display with respect to axes of L*, a*, b* but also a display in which distance and direction of a viewpoint are varied. Further, it is possible to display only the specified area of a profile through designation of a limit of CMYK % to be plotted. When a set up of a view column displayed at the upper portion of the image plane shown in FIG. 20 is altered by the mouse operation, it is possible to advance the working process for creation of a profile.

FIG. 21 is a view showing an example of the image plane 82a (cf. FIG. 2) displayed on the display screen of an image display unit 82, for execution of the creation of a profile.

The image plane shown in FIG. 21 is displayed when the set up of the view column shown in FIG. 20 is altered to “ab Plane”.

This image plane shows a projection of the created profile to an a*b* plane. Operation of various buttons displayed lower the image plane by the mouse makes it possible to designate an area to be displayed with respect to the L* axis. When the mouse cursor is superposed on a desired plotting point, the CMYK values and the L*a*b* values at the position of the plotting point are displayed lower right the image plane. When a set up of a view column displayed at the upper portion of the image plane shown in FIG. 21 is altered by the mouse operation, it is possible to advance the working process for creation of a profile.

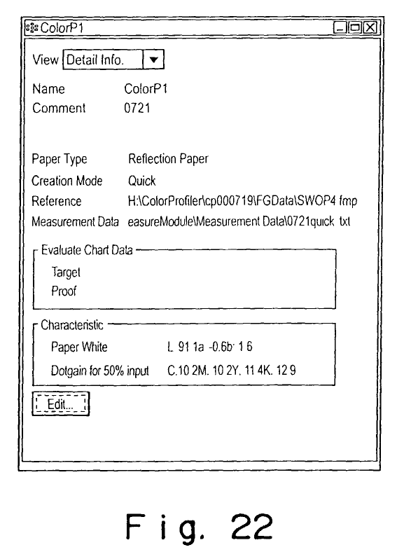

FIG. 22 is a view showing an example of the image plane 82a (cf. FIG. 2) displayed on the display screen of an image display unit 82, for execution of the creation of a profile.

The image plane shown in FIG. 22 is displayed when the set up of the view column shown in FIG. 21 is altered to “Detail info.”.

This image plane displays profile names, creation modes, measured data used in creation, and base profile names (only in case of the easiness creation mode), for the created profile. When an “Edit” button displayed below the image plane shown in FIG. 22 is clicked, it is possible to advance the working process for creation of a profile.

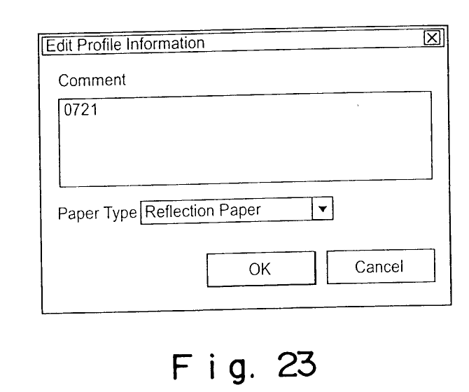

FIG. 23 is a view showing an example of the image plane 82a (cf. FIG. 2) displayed on the display screen of an image display unit 82, for execution of the creation of a profile.

The image plane shown in FIG. 23 is displayed when the “Edit” button shown in FIG. 22 is clicked.

At the upper portion of the image plane, there is displayed a frame for editing a comment of the created profile. Below the frame a column for selection of a paper type is provided. It is possible to input an arbitrary character string for the comment. Regarding the paper type, the closest one is selected from the list. When an “OK” button displayed below the image plane shown in FIG. 23 is clicked, it is possible to advance the working process for creation of a profile.

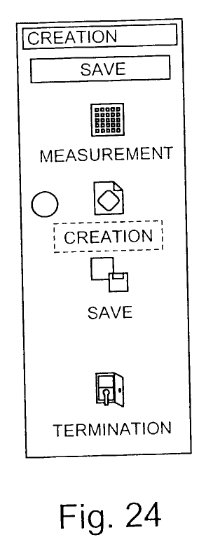

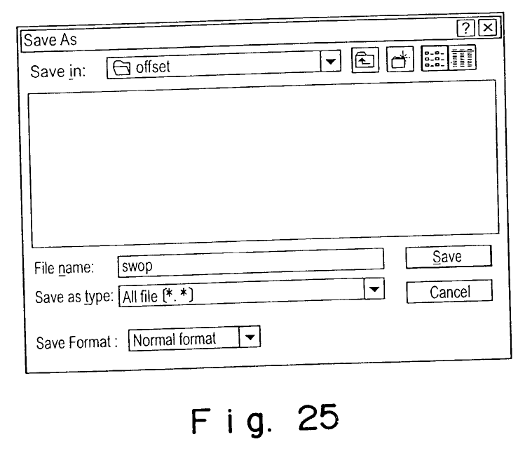

FIG. 24 is a view showing an example of a work-icon display image plane displayed on the image plane 82a (cf. FIG. 2) displayed on the display screen of an image display unit 82 by the works-icon image plane display section 812 of the profile creating apparatus 800 shown in FIG. 8.

The works-icon image plane shown in FIG. 24 is displayed when the “OK” button shown in FIG. 23 is clicked.

Here, of a “measurement” work-icon, a “creation” work-icon, a “saving” work-icon, and a “termination” work-icon, which are disposed and displayed in the same order as the working procedure of the series of works for creation of a profile from the upper part to the lower part of the image plane, the index, which is indicative of that the command to be executed next is the “saving” work-icon, is displayed at the left side of the “saving” work-icon.

Here, it is permitted that only the “creation” work-icon, the “saving” work-icon, and the “termination” work-icon are designated by the command execution section 813 of the profile creating apparatus 800 shown in FIG. 8.

Other points of the work-icon image plane shown in FIG. 24 and the details of the functions are the same as the work-icon image plane shown in FIG. 11, and thus redundant explanation will be omitted.

When the “saving” work-icon displayed on the work-icon image plane shown in FIG. 24 is clicked, it is possible to advance the working process for creation of a profile.

FIG. 25 is a view showing an example of the image plane 82a (cf. FIG. 2) displayed on the display screen of an image display unit 82, for execution of the creation of a profile.

The works-icon image plane shown in FIG. 25 is displayed when the “saving” work-icon shown in FIG. 24 is clicked.

This image plane is an image plane in which the created profile is named and saved. A set up for saving data is completed in such a manner that a folder, in which data is to be saved, is designated in a “Save in” column displayed upper the image plane, a desired file name is entered into a “File name” column displayed lower the image plane, and a type of the file is selected in a “Save as type” displayed below the “File name” column. According to the present embodiment, a format of data to be saved is set up to a “Normal Format” once. After the completion of set up, a “Save” button displayed lower right the image plane is clicked, so that the created profile is saved in form of the “Normal Format”, and the process goes to the subsequent working process for creation of a profile.

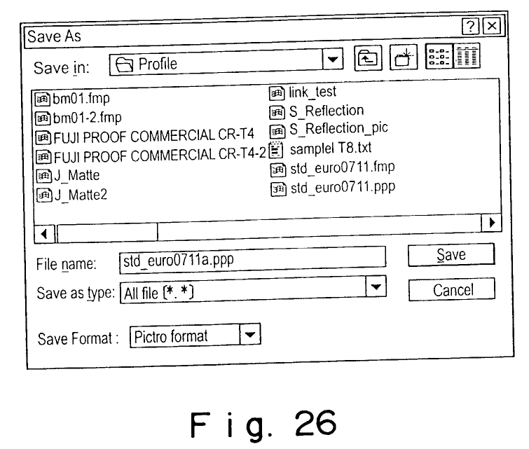

FIG. 26 is a view showing an example of the image plane 82a (cf. FIG. 2) displayed on the display screen of an image display unit 82, for execution of the creation of a profile.

The works-icon image plane shown in FIG. 26 is displayed when the “save” button shown in FIG. 25 is clicked.

This image plane is the same as the image plane shown in FIG. 25, and thus the redundant explanation will be omitted. According to the present embodiment, in order to convert the format of data in which data is saved in form of the “Normal Format”, a format of data is set up to a “Pictro Format”. After completion of the set up, a “Save” button displayed lower right the image plane is clicked, so that the created profile is saved in form of the “Pictro Format”, and the working process for creation of a profile is completed.

As mentioned above, according to the profile creating apparatus including an embodiment of the command execution apparatus of the present invention, a plurality of work-icons is arranged and displayed on the works-icon image plane in the same order as a series of works of working procedure for creation of a profile. Accordingly, any one can grasp the entirety of the working procedure from the arrangement of the plurality of working icons and in addition can advance the works without considering the subsequent operation in the mid way of the works by sequentially designating the work-icons arranged in the same order as a series of works of working procedure. As a result, there is provide a command execution apparatus capable of reliably and smoothly executing a plurality of commands to be executed in accordance with a predetermined working procedure. Further, an operator can grasp the work to be executed next by an indication of index of the work-icon in which the command to be executed next is defined, and by an indication of an explanatory note for the command to be executed next, and in addition can complete the works more reliably by advancing the works in accordance with those indications. Furthermore, limiting the work-icons that receive the designation makes it possible, for example, to avoid such an operator's mistake that an erroneous work-icon is designated omitting the necessary work, and thus it is possible to terminate the works more reliably. Still further, according to the profile creating apparatus including an embodiment of the command execution apparatus of the present invention, it is permitted also to receive the designation of the work-icon in which the command executed immediately before is defined, and thus it is possible also to alter the processed contents which are determined once in the work just before, for example, such a case where a mistake of setting in the previous step is corrected in the mid way of a series of works. Still furthermore, according to the profile creating apparatus including an embodiment of the command execution apparatus of the present invention, a result, which is obtained by the execution of the command associated with any one of work-icons, is set up as data used when the command to be executed next is executed, so that an operator's manual operation for performing such a set up can be omitted. Thus, it is possible to reduce the burden of an operator and in addition to reduce a possibility of the occurrence of setting errors as compared with the manual setting. Therefore, it is possible to complete the works more reliably.

Next, there will be explained the second embodiment. According to the above-mentioned first embodiment, a series of works for creating a profile is executed when the “creation” consecutive works-icon displayed upper the consecutive works-icon display image plane shown in FIG. 10 is clicked. On the other hand, according to the second embodiment which will be described hereinafter, a series of works for accuracy evaluation and control of a profile is executed when the “evaluation” consecutive works-icon displayed upper the consecutive works-icon display image plane shown in FIG. 10 is clicked.

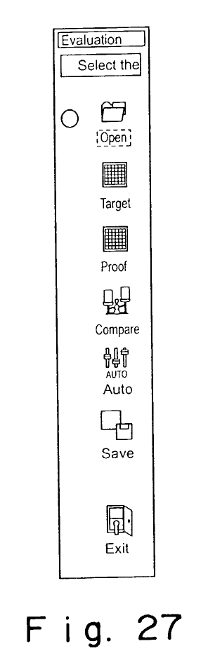

FIG. 27 is a view showing an example of a work-icon display image plane displayed on the image plane 82a (cf. FIG. 2) displayed on the display screen of an image display unit 82 by the works-icon image plane display section 812 of the profile creating apparatus 800 shown in FIG. 8.

A works-icon image plane shown in FIG. 27 is displayed when the “evaluation” consecutive works-icon displayed upper the consecutive works-icon display image plane shown in FIG. 10 is clicked.

Here, of an “Open” work-icon, a “Target” work-icon, a “Proof” work-icon, a “Compare” work-icon, a “Auto” work-icon, a “Save” work-icon, and a “Exit” work-icon, which are disposed and displayed in the same order as the working procedure of the series of works for accuracy evaluation and control of a profile from the upper part to the lower part of the image plane, the index, which is indicative of that the command to be executed next is the “Open” work-icon, is displayed at the left side of the “Open” work-icon.

Here, it is permitted that only the “Open” work-icon, and the “Exit” work-icon are designated by the command execution section 813 of the profile creating apparatus 800 shown in FIG. 8.

Other points of the work-icon image plane shown in FIG. 27 and the details of the functions are the same as the work-icon image plane shown in FIG. 11, and thus redundant explanation will be omitted.

Here, the “Open” work-icon displayed on the work-icon image plane shown in FIG. 27 is clicked, so that a profile, which is to be subjected to accuracy evaluation and control of a profile, is selected and opened on an image plane (not illustrated).

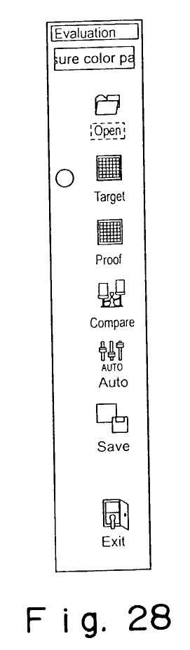

FIG. 28 is a view showing an example of a work-icon display image plane displayed the image plane 82a (cf. FIG. 2) displayed on the display screen of an image display unit 82 by the works-icon image plane display section 812 of the profile creating apparatus 800 shown in FIG. 8.

A works-icon image plane shown in FIG. 28 is displayed when an “OK” button provided on an image plane (not illustrated) on which a profile to be subjected to accuracy evaluation and control of a profile is opened, is clicked.

Here, of an “Open” work-icon, a “Target” work-icon, a “Proof” work-icon, a “Compare” work-icon, a “Auto” work-icon, a “Save” work-icon, and a “Exit” work-icon, which are disposed and displayed in the same order as the working procedure of the series of works for accuracy evaluation and control of a profile from the upper part to the lower part of the image plane, the index, which is indicative of that the command to be executed next is the “Target” work-icon, is displayed at the left side of the “Target” work-icon.

Here, it is permitted that only the “Open” work-icon, the “Target” work-icon and the “Exit” work-icon are designated by the command execution section 813 of the profile creating apparatus 800 shown in FIG. 8.

Other points of the work-icon image plane shown in FIG. 28 and the details of the functions are the same as the work-icon image plane shown in FIG. 11, and thus redundant explanation will be omitted.

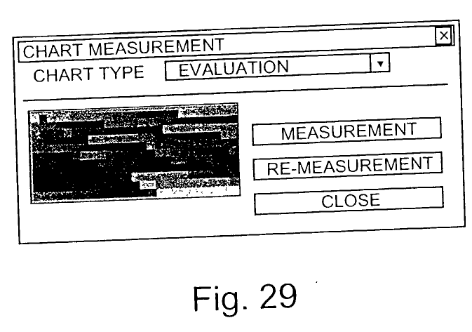

FIG. 29 is a view showing an example of the image plane 82a (cf. FIG. 2) displayed on the display screen of an image display unit 82, for execution of the accuracy evaluation and control of a profile.

When the “Target” work-icon shown in FIG. 28 is clicked, the command execution section 813 of the profile creating apparatus 800 shown in FIG. 8 executes the command associated with the designated work-icon, so that an image plane shown in FIG. 29 is displayed.

According to the present embodiment, as the color chart used in accuracy evaluation and control of a profile, there is prepared a color chart of target “evaluation”. FIG. 29 shows an image plane in which an image for a color chart of target “evaluation” (here this image is also referred to as the color chart) is displayed. When an operator clicks a “Measurement” button displayed lower right the image plane shown in FIG. 29, it is possible to advance the working process for accuracy evaluation and control of a profile.

With respect to the measurement procedure for the color chart of the target “evaluation” for executing accuracy evaluation and control of a profile, other points are the same as the measurement procedure for the color chart for executing a creation of a profile, shown in FIG. 13 to FIG. 16, and the redundant explanation will be omitted.

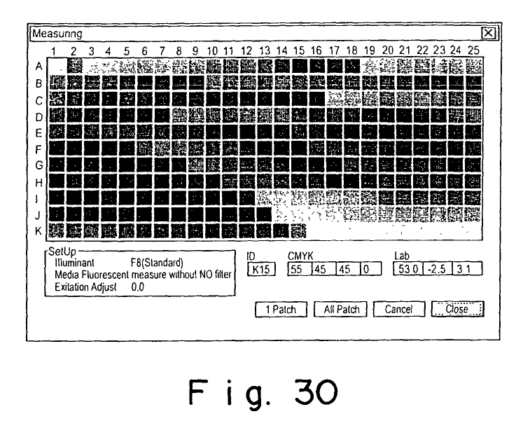

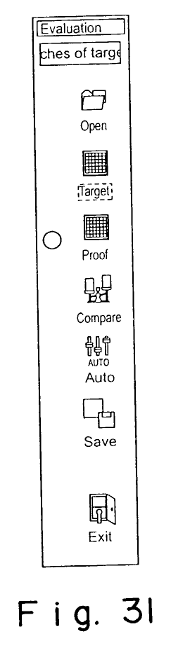

FIG. 30 is a view showing an example of a form image plane displayed on the image plane 82a (cf. FIG. 2) displayed on the display screen of an image display unit 82, for execution of the accuracy evaluation and control of a profile. Here, there is prepared a form according to the color chart of the target “evaluation”.

A form image plane shown in FIG. 30 is the same as the form image plane in measurement shown in FIG. 16 except for the point that a frame upper the image plane, on which an image for color patches associated with the color patches of the measured color chart (here this image is also referred to as the color chart) is displayed, is a frame according to the color chart of target “evaluation”, and thus the redundant explanation will be omitted.

After the termination of the measurement of all the color patches, clicking of a “Close” button displayed lower right on the form image plane makes it possible to advance the working process for accuracy evaluation and control of a profile.

When the “Close” button shown in FIG. 30 is clicked, there is displayed an image plane (not illustrated) in which measured data obtained through a measurement of color patches of the color chart are named and saved, similar to the image plane in which measured data shown in FIG. 17 are named and saved. And measured data obtained through a measurement of color patches of the color chart of the target “evaluation” are named and saved in accordance with the operation as explained in conjunction with FIG. 17.

FIG. 31 is a view showing an example of a work-icon display image plane displayed on the image plane 82a (cf. FIG. 2) displayed on the display screen of an image display unit 82 by the works-icon image plane display section 812 of the profile creating apparatus 800 shown in FIG. 8.

A works-icon image plane shown in FIG. 31 is displayed when an “OK” button provided on an image plane (not illustrated) when the measured data obtained through a measurement of color patches of the color chart of the target “evaluation” are named and saved, is clicked.

Here, of an “Open” work-icon, a “Target” work-icon, a “Proof” work-icon, a “Compare” work-icon, a “Auto” work-icon, a “Save” work-icon, and a “Exit” work-icon, which are disposed and displayed in the same order as the working procedure of the series of works for accuracy evaluation and control of a profile from the upper part to the lower part of the image plane, the index, which is indicative of that the command to be executed next is the “Proof” work-icon, is displayed at the left side of the “Proof” work-icon.

Here, it is permitted that only the “Target” work-icon, the “Proof” work-icon and the “Exit” work-icon are designated by the command execution section 813 of the profile creating apparatus 800 shown in FIG. 8.

Other points of the work-icon image plane shown in FIG. 31 and the details of the functions are the same as the work-icon image plane shown in FIG. 11, and thus redundant explanation will be omitted.

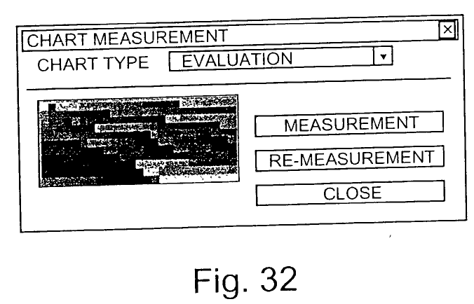

FIG. 32 is a view showing an example of the image plane 82a (cf. FIG. 2) displayed on the display screen of an image display unit 82, for execution of the accuracy evaluation and control of a profile.

When the “Proof” work-icon shown in FIG. 28 is clicked, the command execution section 813 of the profile creating apparatus 800 shown in FIG. 8 executes the command associated with the designated work-icon, so that an image plane shown in FIG. 32 is displayed.

According to the present embodiment, as the color chart used in accuracy evaluation and control of a profile, there is prepared a color chart of proof “evaluation”. FIG. 29 shows an image plane in which an image for a color chart of proof “evaluation” (here this image is also referred to as the color chart) is displayed. When an operator clicks a “Measurement” button displayed lower right the image plane shown in FIG. 29 is clicked, it is possible to advance the working process for accuracy evaluation and control of a profile.

With respect to the measurement procedure for the color chart of the proof “evaluation” for executing accuracy evaluation and control of a profile, other points are the same as the measurement procedure for the color chart for executing a creation of a profile, shown in FIG. 13 to FIG. 16, and the redundant explanation will be omitted.

Here, there is displayed an image plane (not illustrated) in which measured data obtained through a measurement of color patches of the color chart are named and saved, similar to the image plane in which measured data shown in FIG. 17 are named and saved. And measured data obtained through a measurement of color patches of the color chart of the proof “evaluation” are named and saved in accordance with the operation as explained in conjunction with FIG. 17.

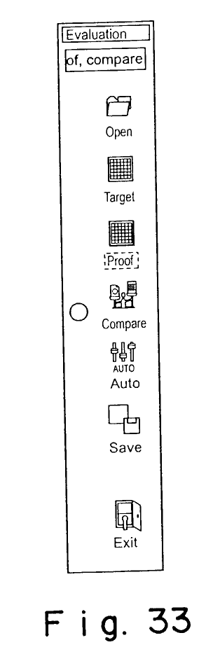

FIG. 33 is a view showing an example of a work-icon display image plane displayed on the image plane 82a (cf. FIG. 2) displayed on the display screen of an image display unit 82 by the works-icon image plane display section 812 of the profile creating apparatus 800 shown in FIG. 8.

A works-icon image plane shown in FIG. 33 is displayed when an “OK” button provided on an image plane (not illustrated) when the measured data obtained through a measurement of color patches of the color chart of the proof “evaluation” are named and saved, is clicked.

Here, of an “Open” work-icon, a “Target” work-icon, a “Proof” work-icon, a “Compare” work-icon, a “Auto” work-icon, a “Save” work-icon, and a “Exit” work-icon, which are disposed and displayed in the same order as the working procedure of the series of works for accuracy evaluation and control of a profile from the upper part to the lower part of the image plane, the index, which is indicative of that the command to be executed next is the “Compare” work-icon, is displayed at the left side of the “Compare” work-icon.

Here, it is permitted that only the “Proof” work-icon, the “Compare” work-icon and the “Exit” work-icon are designated by the command execution section 813 of the profile creating apparatus 800 shown in FIG. 8.

Other points of the work-icon image plane shown in FIG. 33 and the details of the functions are the same as the work-icon image plane shown in FIG. 11, and thus redundant explanation will be omitted.

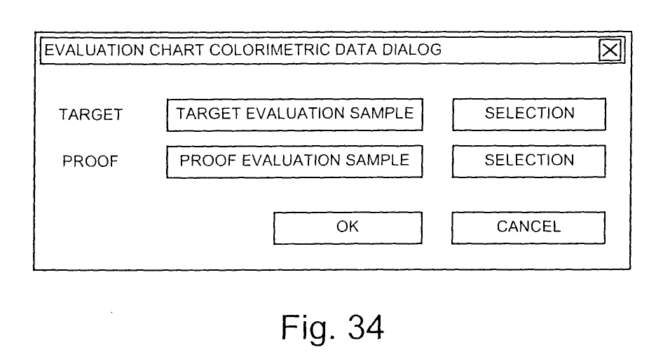

FIG. 34 is a view showing an example of the image plane 82a (cf. FIG. 2) displayed on the display screen of an image display unit 82, for execution of the accuracy evaluation and control of a profile.

When the “Compare” work-icon shown in FIG. 33 is clicked, the command execution section 813 of the profile creating apparatus 800 shown in FIG. 8 executes the command associated with the designated work-icon, so that an image plane shown in FIG. 34 is displayed.

Here, there is shown an image plane in which both measured data obtained through measurement of color patches of the color chart of target “evaluation”, and measured data obtained through measurement of color patches of the color chart of proof “evaluation”, which are named and saved in the above-mentioned process by the command execution section 813 of the profile creating apparatus 800 shown in FIG. 8, are set up, as measured data, in a target column and a proof column shown in FIG. 34, respectively. When an “OK” button displayed lower the image plane shown in FIG. 34 is clicked, a work for creation of a profile is executed and it is possible to advance the working process for accuracy evaluation and control of a profile.

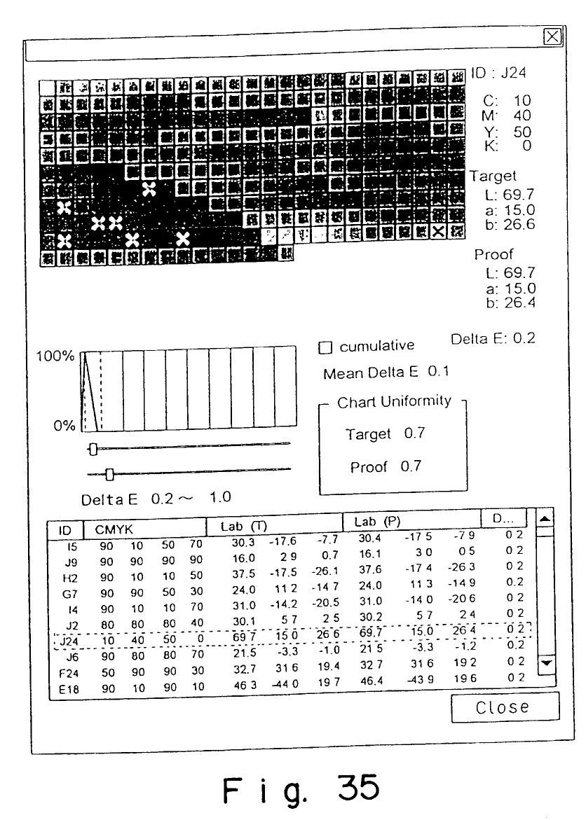

FIG. 35 is a view showing an example of the image plane 82a (cf. FIG. 2) displayed on the display screen of an image display unit 82, for execution of the accuracy evaluation and control of a profile.

An image plane shown in FIG. 35 is displayed when the “OK” button shown in FIG. 34 is clicked.

The image plane shown in FIG. 35 shows an evaluation chart comparison dialog created in accordance with both the measured data obtained through measurement of color patches of the color chart of target “evaluation”, and the measured data obtained through measurement of color patches of the color chart of proof “evaluation”, shown in FIG. 34.

As shown in FIG. 35, an image (here this image is also referred to as the color chart) for color patches associated with the color patches of the color chart of target “evaluation” measured is displayed in the frame upper the evaluation chart comparison dialog. When the mouse cursor meets any one of a plurality of color patches displayed in the frame, there are displayed, at the right side of the frame, ID of a color patch designated by the mouse cursor, CMYK values, L*a*b* values (Target) in which the CMYK values are converted using a printing profile, L*a*b* values (Proof) in which the CMYK values are converted using a printer profile, and a color difference (Delta E) between the target and the proof. Lower left the frame of the evaluation chart comparison dialog, there is displayed a graph representative of a distribution of a color difference between the target and the proof with respect to a plurality of color patches constituting a color chart. When a check box “cumulative”, which is displayed at the right side of the graph, is set up to be effective, the graph representative of the distribution of the color difference shown in FIG. 35 by way of example is replaced by a graph representative of a cumulative distribution of the color difference. Below the graph, there are provided two slide bars. The slide bars make it possible to designate a desired color difference range. At the right of the slide bars, there is displayed mean color difference and chart uniformity. Further, at the lower part of the evaluation chart comparison dialog, there is displayed information for the plurality of color patches displayed in the frame at the upper part of the evaluation chart comparison dialog, specifically, ID of a color patch, CMYK values, L*a*b* values (Lab (T)) in which the CMYK values are converted using a printing profile, L*a*b* values (Lab (P)) in which the CMYK values are converted using a printer profile, and a color difference (D) between the target and the proof. When a “Close” button displayed lower right the evaluation chart comparison dialog of the image plane shown in FIG. 35 is clicked, it is possible to advance the working process for accuracy evaluation and control of a profile.

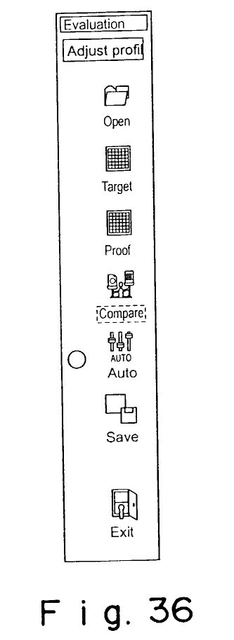

FIG. 36 is a view showing an example of a work-icon display image plane displayed the image plane 82a (cf. FIG. 2) displayed on the display screen of an image display unit 82 by the works-icon image plane display section 812 of the profile creating apparatus 800 shown in FIG. 8.

A works-icon image plane shown in FIG. 36 is displayed when the “Close” button shown in FIG. 35 is clicked.

Here, of an “Open” work-icon, a “Target” work-icon, a “Proof” work-icon, a “Compare” work-icon, a “Auto” work-icon, a “Save” work-icon, and a “Exit” work-icon, which are disposed and displayed in the same order as the working procedure of the series of works for accuracy evaluation and control of a profile from the upper part to the lower part of the image plane, the index, which is indicative of that the command to be executed next is the “Auto” work-icon, is displayed at the left side of the “Auto” work-icon.

Here, it is permitted that only the “Compare” work-icon, the “Auto” work-icon, and the “Exit” work-icon are designated by the command execution section 813 of the profile creating apparatus 800 shown in FIG. 8.

Other points of the work-icon image plane shown in FIG. 36 and the details of the functions are the same as the work-icon image plane shown in FIG. 11, and thus redundant explanation will be omitted.

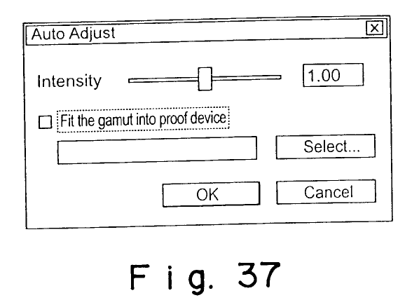

FIG. 37 is a view showing an example of the image plane 82a (cf. FIG. 2) displayed on the display screen of an image display unit 82, for execution of the accuracy evaluation and control of a profile.

When the “Auto” work-icon shown in FIG. 36 is clicked, the command execution section 813 of the profile creating apparatus 800 shown in FIG. 8 executes the command associated with the designated work-icon, so that an image plane shown in FIG. 37 is displayed.

This image plane is for controlling a profile to be subjected to the accuracy evaluation and control of a profile, which is opened beforehand by clicking the “Open” work-icon shown in FIG. 27 using the color difference between the target and the proof, shown in FIG. 35. At the upper part of this image plane, there is displayed a slide bar for designating “Intensity” (control intensity). Usually, as the value, “1.0” is the base. In the event that the color reproduction area of a proofer is narrower than that of a target, a check box of “Fit the gamut into proof device” displayed under the slide bar is set to be effective so that the color reproduction area has no effect in control. After completion of the set up, when an “OK” button displayed lower the image plane shown in FIG. 37 is clicked, a work for creation of a profile is executed and it is possible to advance the working process for accuracy evaluation and control of a profile.

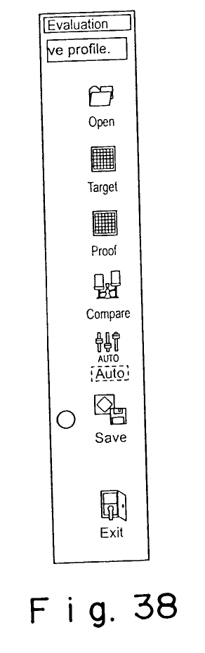

FIG. 38 is a view showing an example of a work-icon display image plane displayed on the image plane 82a (cf. FIG. 2) displayed on the display screen of an image display unit 82 by the works-icon image plane display section 812 of the profile creating apparatus 800 shown in FIG. 8.

A works-icon image plane shown in FIG. 38 is displayed when the “OK” button shown in FIG. 37 is clicked.

Here, of an “Open” work-icon, a “Target” work-icon, a “Proof” work-icon, a “Compare” work-icon, a “Auto” work-icon, a “Save” work-icon, and a “Exit” work-icon, which are disposed and displayed in the same order as the working procedure of the series of works for accuracy evaluation and control of a profile from the upper part to the lower part of the image plane, the index, which is indicative of that the command to be executed next is the “Save” work-icon, is displayed at the left side of the “Save” work-icon.

Here, it is permitted that only the “Auto” work-icon, the “Save” work-icon, and the “Exit” work-icon are designated by the command execution section 813 of the profile creating apparatus 800 shown in FIG. 8.

Other points of the work-icon image plane shown in FIG. 36 and the details of the functions are the same as the work-icon image plane shown in FIG. 11, and thus redundant explanation will be omitted.

When the “Save” work-icon shown in FIG. 38 is clicked, there is displayed an image plane (not illustrated) in which profiles are named and saved, similar to the image plane in which the profiles shown in FIG. 25 are named and saved. And the corrected profile, which is obtained through execution of the accuracy evaluation and control of a profile, is named and saved in accordance with the operation as explained in conjunction with FIG. 25. When the “Save” button displayed lower right the image plane (not illustrated) in which profiles are named and saved is clicked, it is possible to complete the working process for accuracy evaluation and control of a profile.

Next, there will be explained an example of a procedure in which the works procedure creating section 814 of the profile creating apparatus 800 shown in FIG. 8 creates an arrangement of work-icons on a work-icon display image plane in accordance with an operation by a pointing device such as a mouse.

Here, there will be explained an example of a procedure in which a working procedure of a series of works is newly created, and an arrangement of work-icons of the same order as the working procedure of the series of works is created on a work-icon image plane.

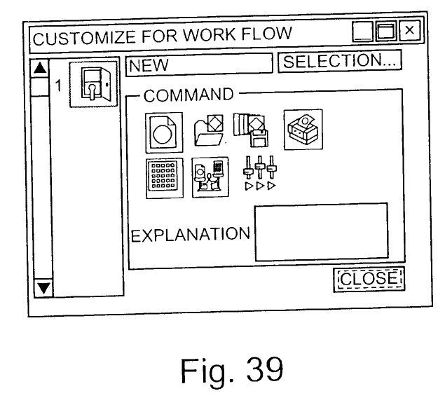

FIG. 39 is a first view showing an example of a customize image plane for a work flow to create an arrangement of work-icons on a work-icon display image plane, which is displayed on the image plane 82a (cf. FIG. 2) displayed on the display screen of an image display unit 82.

An image plane shown in FIG. 39 shows an initial image plane for newly creating a working procedure of a series of works, which is displayed when a “selection” button provided upper right the image plane is clicked to select a “new” from among selection items (not illustrated). In this state, there is displayed only an icon representative of a “termination” in a frame displayed at the left of the image plane. In a command column below a “selection” button at the right side of the image plane, there is displayed a list of icons which can be used in works for creation of an arrangement of work-icons, such as addition, deletion and rearrangement of work-icons. Below the list of icons, there is provided an explanatory note input column into which an explanatory note for an added icon after addition work for a desired icon, which will be described later.

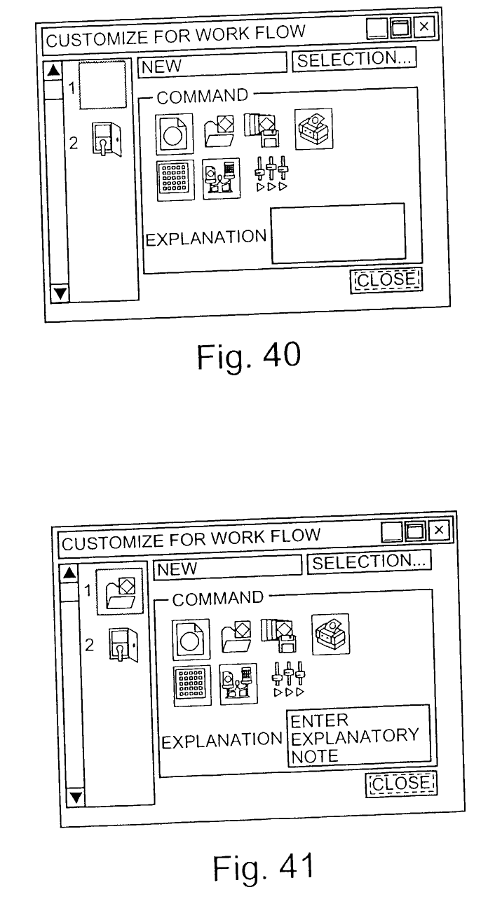

FIG. 40 is a second view showing an example of a customize image plane for a work flow to create an arrangement of work-icons on a work-icon display image plane, which is displayed on the image plane 82a (cf. FIG. 2) displayed on the display screen of an image display unit 82.

Here, there is shown a state that a space for inserting a new icon is created on a “termination” icon, which is displayed within a frame left the image plane, by selection of an “addition” from a quick menu (not illustrated), which is displayed when the “termination” icon is selected by a pointing device such as a mouse and is clicked. When the “deletion” is selected from the quick menu, it is possible to delete the selected work-icon from the arrangement of the work-icons. Further, a combination of works of the “addition” and the “deletion” makes it possible to perform a rearrangement of the work icons.

FIG. 41 is a third view showing an example of a customize image plane for a work flow to create an arrangement of work-icons on a work-icon display image plane, which is displayed on the image plane 82a (cf. FIG. 2) displayed on the display screen of an image display unit 82.

Here, there is shown a state that an “open a profile” icon is inserted into a space shown in FIG. 40 by a mouse operation, and an explanatory note for the icon is entered into an explanatory note input column provided below a list of icons.

Lower right the image plane shown in FIG. 39, FIG. 40, and FIG. 41, there is displayed a “Close” button. When the “Close” button is clicked, the work at the time point when the “close” button is clicked is determined.

Upper right the image plane shown in FIG. 39, FIG. 40, and FIG. 41, there is displayed a “Selection” button. When the “Selection” button is clicked to select a “New” from among selection items (not illustrated), there is displayed the “New”. It is noted, however, that the “New” can be replaced by a name associated with the arrangement of the work-icons to be created. This name corresponds to a name of the series work-icons shown in FIG. 10. This name makes it possible to specify the arrangement of the work-icons created on the work-icon image plane.

Incidentally, according to the present embodiment, the procedure of creating an arrangement of the work-icons on the work-icon image plane has been explained taking an example of a procedure in which a working procedure of a series of works is newly created, and an arrangement of work-icons of the same order as the working procedure of the series of works is created on a work-icon image plane. However, the works procedure creation section of the present invention is not restricted to such an example. It is acceptable that the procedure of creating an arrangement of the work-icons on the work-icon image plane is a procedure that a working procedure of a series of works, which has been already created, is changed or modified to meet an operator's requirement, and an arrangement of work-icons of the same order as the working procedure of the series of works thus changed or modified is created on the work-icon image plane.

For example, there is raised one in which when the “selection” button provided upper right the image plane shown in FIG. 39 is clicked, a series of works, which has been already created, is specified, for example, the “creation” and the “evaluation”, which are the names of the consecutive work-icons, can be selected. Accordingly, when the “selection” button is clicked to select a desired consecutive work-icon from among selection items (not illustrated), it is possible to change or modify a working procedure of a series of works, which has been already created, corresponding to the consecutive work-icon of the selected name. In this case, in the frame displayed at the left of the image plane shown in FIG. 39, the work-icon corresponding to the consecutive work-icon thus selected is arranged and displayed in the same order as the working procedure of the series of works. The procedure following works of creating an arrangement of work-icons, such as addition, deletion and rearrangement of work-icons, is the same as the procedure of creating an arrangement of work-icons shown in FIG. 39 and FIG. 40, and thus the redundant explanation will be omitted.

As mentioned above, according to the command execution apparatus having the works procedure creation section, it is possible to change or modify a working procedure of a series of works, which has been already created, and also to newly create a working procedure of a series of works. Accordingly, it is possible to create an arrangement of work icons to meet an operator's requirement on a work-icon image plane.

As mentioned above, according to the present invention, there is provided a command execution apparatus wherein a plurality of commands, which is executed in accordance with a predetermined working procedure, is surely and smoothly executed in accordance with the predetermined working procedure, and a command execution program storage medium storing a command execution program which causes a computer to operate as such a command execution apparatus when the command execution program is incorporated into the computer.

Although the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A command execution apparatus having a display screen and a pointing device, wherein an icon, in which a command is defined, is displayed on the display screen and the command is executed in accordance with the icon designated upon receipt of an instruction of the icon by the pointing device, said command execution apparatus comprising:
a consecutive works-icon display section for displaying on the display screen a consecutive works-icon associated with a series of works;
a works-icon image plane display section for displaying on the display screen, upon receipt of designation of the consecutive works-icon by the pointing device, a works-icon image plane associated with the consecutive works-icon, in which a plurality of works-icons defining commands according to plural works constituting a series of works, is arranged in the same order as the working procedure of the series of works; and
a command execution section for executing, upon receipt of designation of any one of the works-icons on the works-icon image plane displayed on the display screen, by the pointing device, a command according to the designated works-icon.

2. A command execution apparatus according to claim 1, wherein said works-icon image plane display section displays a works-icon image plane including a display indexing a works-icon defining a command to be executed next.

3. A command execution apparatus according to claim 2, wherein said works-icon image plane display section displays an explanatory note for a command to be executed next.

4. A command execution apparatus according to claim 1, wherein said command execution section receives only either one designation of the works-icon in which the command immediately before executed is defined and the works-icon in which the command to be next executed is defined, of the works-icons arranged on the works-icon image plane, except for receiving an instruction of cancellation of a series of works associated with the works-icon image plane.

5. A command execution apparatus according to claim 1, wherein said command execution section sets up a result obtained by execution of a command associated with any of the works-icons on the works-icon image plane in form of data that is used when a command to be executed subsequently to the command (first occurrence) is executed.

6. A command execution apparatus according to claim 1, wherein said command execution apparatus further comprises a works procedure creating section for creating an arrangement of the works-icons on the works-icon image plane in accordance with an operation of the pointing device.

7. A command execution program storage medium storing a command execution program, which causes a computer having a display screen and a pointing device to operate as a command execution apparatus wherein an icon, in which a command is defined, is displayed on the display screen and the command is executed in accordance with the icon designated upon receipt of an instruction of the icon by the pointing device, when the color command execution program is incorporated in the computer to be executed, said color command execution apparatus comprising:
a consecutive works-icon display section for displaying on the display screen a consecutive works-icon associated with a series of works;
a works-icon image plane display section for displaying on the display screen, upon receipt of designation of the consecutive works-icon by the pointing device, a works-icon image plane associated with the consecutive works-icon, in which a plurality of works-icons defining commands according to plural works constituting a series of works, is arranged in the same order as the working procedure of the series of works; and
a command execution section for executing, upon receipt of designation of any one of the works-icons on the works-icon image plane displayed on the display screen, by the pointing device, a command according to the designated works-icon.
